(19) United States
(12) Patent Application Publication
(10) Pub. No.: US 2026/0340348 A1
(43) Pub. Date: Oct. 29, 2026

(54) SYSTEMS AND METHODS FOR EXTRACTING AND MATCHING ATTRIBUTES FROM DOCUMENTS

(71) Applicant: Accenture Global Solutions Limited, Dublin (IE)

(72) Inventors: Nitu NIVEDITA, Atlanta, GA (US); Sally LIN, Long Island City, NY (US); Deepak KRISHNA, Trivandrum District (IN); Shubhangi MEHROTRA, Gurgaon (IN); Vaishangi BAJPAI, Noida (IN); Vinothini MADASAMY, Sivagangai (IN); Almore Joseph CATO, II, New Orleans, LA (US); Conor Austin FOLAN, San Francisco, CA (US); Nithyashree DASEGOWDA, Bangalore (IN); Lavanya LAKSHMAN, Bangalore (IN); Sharad Kant DUBEY, Noida (IN)

(73) Assignee: Accenture Global Solutions Limited, Dublin (IE)

(21) Appl. No.: 19/189,702

(22) Filed: Apr. 25, 2025

(51) Int. Cl. G06N 3/0455

(52) U.S. Cl. CPC G06N 3/0455

(57) ABSTRACT

Methods, systems, and computer-readable storage media for extracting and matching key attributes from documents are disclosed. Primary documents from various data sources are received. Primary key attributes are extracted from primary documents using fine-tuned Large Language Models (LLMs). Secondary key attributes are determined from secondary documents, using fine-tuned LLMs. Primary key attributes and secondary key attributes are validated, using fine-tuned LLMs. A similarity between primary key attributes, and secondary key attributes is determined based on results of validation. Ontology scores for each of primary key attributes and secondary key attributes are computed, based on similarity. Matched attribute pairs are determined by comparing ontology scores with first predefined threshold value. Gap level between each of matched attribute pairs is identified using fine-tuned LLMs. Transitions to be applied to each of matched attribute pairs are recommended, based on gap level. Recommended transitions are outputted on an interface of client device.

### TECHNICAL FIELD

Various implementations described herein relate generally to systems and methods for extracting and matching attributes from documents.

### BACKGROUND

Document processing is a rapidly growing area within data management and Artificial Intelligence (AI), focused on extraction, analysis, and organization of information from various types of documents. Document processing is applicable across a wide range of enterprises, from legal to healthcare, to streamline workflows, enhance decision-making, and reduce manual efforts. In some examples, the document processing may involve extracting attributes from the various types of documents, comparing the extracted attributes for similarity, and using the attributes with the similarity for further downstream applications.

Enterprises may employ document processing systems for processing the documents. Some of the document processing systems may use tools such as AI-based tools, Natural Language Processing (NLP) tools, Machine Learning (ML) models, Computer Vision based tools, for processing the documents. However, these tools may involve keyword-based search techniques for processing the documents. Therefore, processing of the documents using the keyword-based search techniques may result in inefficient extraction of attributes (e.g., information/data) from the documents by disregarding deeper contextual insights that are required for accurate interpretation of the attributes in the documents, which may further result in inaccurate comparison of the extracted attributes. For example, in a recruitment sector, the document processing systems using the keyword-based search techniques may match a job title to a resume based on keywords, but often fail to consider specific qualifications, proficiency levels, or dynamic nature of job market. Similarly, in legal or financial document processing, the document processing systems using the keyword-based search techniques may overlook context or fail to address evolving standards and regulations that influence interpretation of the documents. Further, due to such limitations, these document processing systems may involve manual processes to validate and compare the extracted attributes. Therefore, the documents may be processed by expending a significant amount of time, human resources, and computing resources (e.g., processing resources, memory resources, communication resources, and/or the like).

### SUMMARY

In an aspect, the present disclosure relates to a system for extracting and matching key attributes from documents. The system includes a processor, and a memory coupled to the processor, wherein the memory includes processor-executable instructions, which on execution, cause the processor to receive a plurality of primary documents from a plurality of data sources. The plurality of primary documents includes synthetic datasets and raw datasets. The plurality of primary documents includes at least one of user demographic documents, user medical documents, user legal documents, and user compliance documents. The processor-executable instructions, on execution, further cause the processor to extract a plurality of primary key attributes from the plurality of primary documents using a plurality of fine-tuned Large Language Models (LLMs). The plurality of primary key attributes includes at least one of a user demographic data, a user qualification data, a user medical data, a user compliance data, and a user proficiency level data. The processor-executable instructions, on execution, further cause the processor to determine a plurality of secondary key attributes from a plurality of secondary documents, using the plurality of fine-tuned LLMs. The plurality of secondary documents includes at least one of target demographic documents, target medical documents, target legal documents, and target compliance documents. The plurality of secondary key attributes includes at least one of a target demographic data, a target qualification data, a target medical data, and a target compliance data, and a target proficiency level data. The processor-executable instructions, on execution, further cause the processor to validate the plurality of primary key attributes, and the plurality of secondary key attributes, using the plurality of fine-tuned LLMs. The processor-executable instructions, on execution, further cause the processor to determine a similarity between the plurality of primary key attributes, and the plurality of secondary key attributes based on results of validation. The processor-executable instructions, on execution, further cause the processor to compute ontology scores for each of the plurality of primary key attributes and the plurality of secondary key attributes, based on the determined similarity. The ontology scores correspond to a similarity level between the plurality of primary key attributes, and the plurality of secondary key attributes. The processor-executable instructions, on execution, further cause the processor to determine a plurality of matched attribute pairs, by comparing the computed ontology scores with a first predefined threshold value. The processor-executable instructions, on execution, further cause the processor to identify a gap level between each of the determined plurality of matched attribute pairs using the plurality of fine-tuned LLMs. The processor-executable instructions, on execution, further cause the processor to recommend a plurality of transitions to be applied to each of the plurality of matched attribute pairs, based on the identified gap level. The plurality of transitions includes performing modifications to the plurality of matched attribute pairs, to match with the first predefined threshold value. The processor-executable instructions, on execution, further cause the process to output the recommended plurality of transitions on an interface of a client device.

In another aspect, the present disclosure relates to a method including receiving, by a processor, a plurality of primary documents from a plurality of data sources, wherein the plurality of primary documents includes synthetic datasets and raw datasets, wherein the plurality of primary documents includes at least one of user demographic documents, user medical documents, user legal documents, and user compliance documents. The method includes extracting, by the processor, a plurality of primary key attributes from the received plurality of primary documents, using a plurality of fine-tuned Large Language Models (LLMs), wherein the plurality of primary key attributes include at least one of user demographic data, user qualification data, user medical data, user compliance data, and user proficiency level data. The method includes determining, by the processor, a plurality of secondary key attributes from a plurality of secondary documents, using the plurality of fine-tuned LLMs, wherein the plurality of secondary documents includes at least one of target demographic documents, target medical documents, target legal documents, and target compliance documents, and wherein the plurality of secondary key attributes includes at least one of a target demographic data, a target qualification data, a target medical data, and a target compliance data, and a target proficiency level data. The method includes validating, by the processor, the extracted plurality of primary key attributes, and the extracted plurality of secondary key attributes, using the plurality of fine-tuned LLMs. The method includes determining, by the processor, a similarity between the plurality of primary key attributes, and the plurality of secondary key attributes based on results of validation, wherein the similarity is determined by applying a semantic similarity model onto the plurality of primary key attributes, and the plurality of secondary key attributes, and wherein the semantic similarity model includes a cosine similarity model. The method includes computing, by the processor, ontology scores for each of the plurality of primary attributes and the plurality of secondary key attributes, based on the determined similarity, wherein the ontology scores correspond to a similarity level between the plurality of primary key attributes, and the plurality of secondary key attributes. The method includes determining, by the processor, a plurality of matched attribute pairs, by comparing the computed ontology scores with a first predefined threshold value. The method includes identifying, by the processor, a gap level between each of the determined plurality of matched attribute pairs using the plurality of fine-tuned LLMs. The method includes recommending, by the processor, a plurality of transitions to be applied to each of the plurality of matched attribute pairs, based on the identified gap level, wherein the plurality of transitions includes performing modifications to the plurality of matched attribute pairs, to match with the first predefined threshold value. The method includes outputting, by the processor, the recommended plurality of transitions on an interface of a client device.

In another aspect, the present disclosure relates to a non-transitory computer-readable medium including machine-executable instructions that may be executable by a processor to perform the method as discussed herein.

It is appreciated that method in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features of the present disclosure will be apparent from the description and drawings, and from the claims.

### BRIEF DESCRIPTION OF THE FIGURES

Various implementations in accordance with the present disclosure will be described with reference to the drawings, in which:

FIG. 1 illustrates an example environment used to execute implementations of the present disclosure.

FIG. 2 illustrates an example architecture of a document processing engine in a document processing system disclosed in the example environment of FIG. 1, for extracting and matching key attributes from documents, in accordance with implementations of the present disclosure.

FIG. 3 depicts an exemplary flow diagram presenting a method for receiving and preprocessing primary documents and secondary documents, in accordance with implementations of the present disclosure.

FIG. 4A depicts an exemplary flow diagram presenting a method for processing primary with respect to secondary documents, in accordance with implementations of the present disclosure.

FIG. 4B depicts an exemplary flow diagram presenting a method for performing skill standardization and description curation, in accordance with implementations of the present disclosure.

FIG. 4C depicts an example illustration of determining similarities between skill pairs/role pairs using cosine similarity, in accordance with implementations of the present disclosure.

FIG. 4D depicts an exemplary flow diagram presenting a method for generating upskilling recommendations, in accordance with implementations of the present disclosure.

FIG. 5 depicts an exemplary flow diagram presenting a method for extracting and matching key attributes from documents, in accordance with implementations of the present disclosure.

FIG. 6 depicts an exemplary flow diagram presenting a method for validating primary key attributes, and secondary key attributes, in accordance with implementations of the present disclosure.

FIG. 7 depicts a flow diagram that presents a method for determining similarity between primary key attributes, and secondary key attributes, in accordance with implementations of the present disclosure.

FIG. 8 depicts a flow diagram that presents a method for recommending transitions to be applied for matched attribute pairs, in accordance with implementations of the present disclosure.

FIG. 9 depicts an example computer system, in accordance with implementations of the present disclosure.

Like reference numbers and designations in the various drawings indicate like elements.

### DETAILED DESCRIPTION

In the following description, various implementations will be illustrated by way of example and not by way of limitation in the figures of the accompanying drawings. References to various implementations in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” and/or the like, are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, and/or the like).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of implementations. However, it will be understood by one of ordinary skill in the art that implementations may be practiced without these specific details. For example, systems may be shown in block diagrams so as not to obscure the implementations in unnecessary detail. In other instances, well-known processes, structures, and techniques may be shown without unnecessary detail in order to avoid obscuring example implementations.

The specification and drawings are to be regarded in an illustrative rather than a restrictive sense. It will, however, be evident that various modifications and changes may be made thereunto without departing from the broader spirit and scope of the disclosure as set forth in the claims.

Implementations of the present disclosure provide a robust and data-driven framework for processing documents. Processing the documents may involve extracting attributes/key attributes from multiple documents, matching attributes, and utilizing the matched attributes for further downstream applications across various domains/industries. For example, the domains may include, but are not limited to, Human Resource (HR) related domains, legal domains, healthcare, and/or the like. The documents may be processed by preprocessing primary and secondary documents, receiving and extracting key attributes from the preprocessed primary and secondary documents, validating and assessing similarity of the key attributes using semantic models, and generating customized recommendations for data transformations. In some examples, Generative Artificial Intelligence (Gen AI) and Machine Learning (ML) techniques, including distributed computing frameworks and Large Language Models (LLMs), to preprocess and process the primary and secondary documents, standardize the extracted key attributes, assess proximity of the key attributes, and generate customized recommendations. The recommendations may be applied to a range of use cases, including internal transitions, external efforts, or other form of data alignment.

Therefore, the documents may be processed by enhancing processing speed, reducing latency, improving data security, and providing actionable insights for ongoing transformations, which may help enterprises to identify optimal matches and support continuous development. Further, the documents may be processed by enhancing accuracy and relevance of attribute matching by considering various factors, including data types, proficiency levels, contextual information, and specific enterprise/organizational priorities. In addition, the documents may be processed by leveraging features such as data security, that provides a capability to process large datasets efficiently, and flexibility to support various applications from internal transitions and external data analysis. Moreover, implementations of the present disclosure may also provide personalized pathways for data transformations, helping enterprises to adapt to evolving needs and technological advancements.

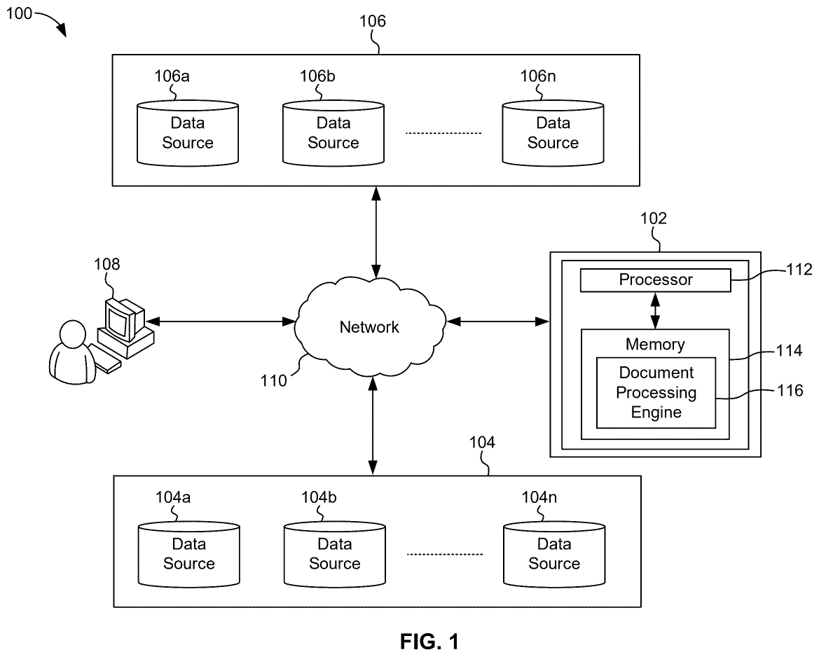

FIG. 1 illustrates an example environment 100 used to execute implementations of the present disclosure. In some examples, the example environment 100 enables processing of documents using Generative Artificial Intelligence (Gen AI) models. Processing of the documents may be applied in various domains/industries such as human resources/recruitment, software development, medical domain/healthcare, education, hospitality, legal services, compliance services, and/or the like. For example, in a recruitment sector, user demographic documents (e.g., resumes) may be processed using the Gen AI models to extract key information.

As depicted in FIG. 1, the example environment 100 includes a document processing system 102, data sources 104a-104n, enterprise data sources 106a-106n, and a client device 108. For brevity, only one client device and one document processing system are depicted in FIG. 1. However, in some implementations, the environment 100 may include multiple client devices and/or document processing systems. In some examples, the document processing system 102 may be implemented as an on-premises system that is operated by an enterprise or a third-party engaged in cross-platform interactions and data management. In some examples, the document processing system 102 may be implemented as an off-premises system (e.g., a cloud or an on-demand system) that is operated by the enterprise or a third-party on behalf of the enterprise. In some other examples, the document processing system 102 may be implemented in a cloud environment. For simplicity, the document processing system 102 depicted in FIG. 1 may be the cloud environment that is intended to represent various forms of servers including a web server, an application server, a proxy server, a network server, a server pool, and/or the like. In some examples, the document processing system 102 may include, but is not limited to a server, a back-end system, a desktop, a laptop, a notebook, a tablet, a smartphone, a mobile phone, an application server, and/or the like.

The document processing system 102 may interact with the data sources 104a-104n, the enterprise data sources 106a-106n, and the client device 108 via a network 110. The network 110 may correspond to a communication network. Examples of the network 110 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. In some examples, the network 110 may be accessed over a wired and/or a wireless communication link.

The data sources 104a-104n may be collectively referenced hereinafter as data sources 104 (also referenced to as databases). The data sources 104 may act as a repository for storing primary documents of users (e.g., candidates, patients, consumers, and/or the like). The primary documents may provide datasets or information related to the various domains/industries. In some examples, the domains/industries may include human resources, medical application/healthcare applications, compliance checking, legal services, invoice management, campaign creation, product and/or service customizations, and/or the like.

The primary documents may be associated with user documents. Examples of the primary documents may include, but are not limited to, user demographic documents, user medical documents, legal documents, compliance documents, and/or the like. As will be understood by those skilled in the art, the primary documents may include other similar documents including the above-described examples. In some examples, the user demographic documents include demographic data of users (e.g., customers using e-commerce applications to purchase products and/or services), which may be used for one or more of: customizing the products and/or services for the users, campaign creation for the products and/or services, and/or the like. In some other examples, the user demographic documents may include user demographic data and qualification data of users (e.g., candidates searching for employment, employees of a company, and/or the like). In such a case, the demographic data and qualification data of the users may be used for HR related applications such as talent matching/sourcing (selecting candidates for jobs), recommending courses or advanced learning for upskilling, internal role transitions, and/or the like. The user medical documents include medical data of users (e.g., patients), which may be used for evaluating condition and/or medical history of the users. As would be understood, the user demographic documents and the user medical documents may be collected, stored, and used based on explicit consents received from the users. Further, the user demographic documents and the user medical documents may be deleted per regulations and prior consents received from the users. Therefore, implementations of the present disclosure may operate only on the small slice of data in the documents that the users have consented to and do not operate on a full brain scan worth of data. The legal documents include legal data, which may be used for analyzing or identifying laws, precedents, interpretations, clauses, agreements or contracts, and/or the like. The compliance documents include a collection of records, policies, procedures, training materials, and/or the like, of organizations/enterprises. The compliance documents may be used to validate whether the respective organizations/enterprises follow industry regulations, legal standards, internal policies, and/or the like.

The primary documents may include the datasets in various formats. By way of non-limiting example, the primary documents may include structured data, unstructured data, semi-structured data, and/or a combination thereof. The structured data may include data files derived from Structured Query Language (SQL) databases, excel files/spreadsheets, web forms, and/or the like. The unstructured data may include text files of various types (e.g., word files, Portable Document Format (PDF) files), image files of various types (e.g., a Joint Photographic Experts Group (JPEG) format, a Portable Network Graphic (PNG) format, a Graphic Interchange Format (GIF) format, and/or the like), video files, emails, presentations, social media posts, and/or the like. The semi-structured data may include Hyper-Text Markup Language (HTML) codes, Extensible Markup Language (XML) data, and/or a combination thereof. Therefore, the primary documents may include structured documents, unstructured documents, semi-structured documents, and/or a combination thereof.

In some examples, the primary documents may include raw datasets and synthetic datasets. The synthetic datasets may refer to artificially created datasets or custom datasets that simulate real documents but with controlled variability and specificity. In some examples, the synthetic datasets may be created using Generative Artificial Intelligence (Gen AI) models and Large Language Models (LLMs). The synthetic datasets may aid in curating datasets that are not readily available.

In an example, if the primary documents include the user demographic documents, the raw datasets may include a heterogenous combination of datasets collected from one or more of: open-source websites, databases, professional networking sites, social media sites, and/or the like, and stored in the data sources 104a-104n. The synthetic datasets may include datasets that have been created using the LLMs (e.g., GPT 4 models) and stored in the data sources 104a-104n. By way of non-limiting example, the synthetic datasets may include datasets that are not available and related to various applications and domains such as green energy, metaverse, Gen-AI, or any other similar domains that have been newly emerged.

In another example, if the primary documents include the user medical documents, the raw datasets may include datasets that have been collected from open sources or databases, specific medical databases (e.g., Medical Information Mart for Intensive Care (MIMIC) databases), ontology based object-oriented databases, and stored in the data sources 104a-104n. The synthetic datasets may include datasets that have been generated using the LLMs (e.g., GPT4 models) and stored in the data sources 104a-104n. In some examples, the synthetic datasets may be created when datasets related to specific medical departments are not available from the open sources and lack standardization. By way of non-limiting example, the specific medical departments may include mental health and psychiatry, pediatrics, oncology, rare diseases departments, and/or the like, for which data privacy regulations are maintained with limited third-party disclosing approaches. For such specific medical departments, the synthetic datasets may be created by providing the LLMs (e.g., GPT4 models) with discharge summary templates, clinical note templates, Chain-of-Thoughts (COT) instructions, and Subject Matter Experts (SMEs)/medical practitioners curated contextual information specific to an individual medical department.

The enterprise data sources 106a-106n may be collectively referred to as enterprise data sources 106. The enterprise data sources 106 may include secondary documents. The secondary documents are associated with the enterprise. The secondary documents may be used to perform various tasks required for the enterprise. Non-limiting examples of the secondary documents may include target demographic documents, target medical documents, target legal documents, and target compliance documents. In an example, the target demographic documents may be used for talent sourcing (e.g., recruiting potential candidates available for job opportunities), internal competency frameworks that define role-specific skills, or learning goals for employee upskilling, and/or the like. By way of non-limiting example, the target demographic documents may include Job Descriptions (JDs) created by the enterprise detailing qualifications, skills, and experiences expected from potential candidates for talent matching or target job roles. In another example, the target demographic documents may include customer segmentation profiles for marketing purposes. Therefore, the target demographic documents are often used in talent sourcing, skill-based matching, campaign targeting, and workforce development initiatives. The target medical documents include medical templates, treatment guidelines, or clinical pathways that are specific to enterprise's healthcare standards. The target medical documents may include discharge summary formats, internal clinical protocols, diagnostic procedures, or anonymized patient summaries that align with enterprise practices. The target legal documents include standard contract templates, compliance guidelines, precedent legal clauses, and case summaries specific to the enterprise or legal jurisdiction. The target compliance documents include internal policy documents, audit checklists, training manuals, and regulatory guidelines that the enterprise adheres to.

The client device 108 may be associated with a client associated with the enterprise. Further, the client device 108 is used by the client to log into and interact with computing platforms provided by the document processing system 102. A computing platform may execute applications according to implementations of the present disclosure. For example, in the recruitment industry, the client may be recruiters, Human Resources (HR) managers, or talent acquisition specialists. In the medical sector, the client may be healthcare professionals such as doctors, medical researchers, or clinical coordinators who use the computing platform to analyze patient records, clinical trials, or medical reports. In the legal sector, the client may be lawyers, paralegals, or legal analysts who utilize the computing platform to process legal documents, review case files, or assist in contract generation and compliance checks. Clients across various sectors leverage the computing platform to streamline document processing and enhance decision-making through data-driven insights.

Examples of the client device 108 may include a server, a notebook, a desktop, a netbook, smartphones, laptops, a tablet, and/or voice-enabled devices. It is contemplated that implementations of the present disclosure may be realized with any appropriate type of client device. In some examples, the client device 108 may include a web browser application executed thereon, which may be used to display one or more web pages of the computing platform executing applications. In some examples, the client device 108 may display one or more Graphical User Interfaces (GUIs) that enable the user to interact with the computing platforms.

By way of an example, the client may use the client device 108 to provide an input to the document processing system 102 and/or receive an output from the document processing system 102. The input may include a request for matching the primary documents and the secondary documents. The output may include results of matching the primary documents and the secondary documents, which is described in detail below.

The document processing system 102 includes a processor 112 and a memory 114. In some implementations, the document processing system 102 includes more than one processor. The processor 112 may include, for example, microprocessors, microcomputers, microcontrollers, digital signal processors, central processing units, state machines, logic circuits, and/or any devices that manipulate data or signals based on operational instructions. The memory 114 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

The memory 114 may be communicatively coupled to the processor 112. The memory 114 stores a document processing engine 116. The document processing engine 116 may be stored as a downloadable library including various instructions. The document processing engine 116 may be executed by the processor 112 for processing the primary documents with respect to the secondary documents. Processing of the primary documents with respect to the secondary documents may include various operations such as receiving the primary documents from the data sources 104, extracting primary key attributes (also referred to as primary entities, primary fields, and/or the like) from the primary documents, receiving the secondary documents from the enterprise data sources 106, determining secondary key attributes (also referred to as primary entities, primary fields, and/or the like) from the secondary documents, validating the primary key attributes and the secondary key attributes, determining similarities between the primary key attributes and the secondary key attributes, computing ontology scores for each of the primary key attributes and the secondary key attributes, determining matched attribute pairs, identifying gap levels, recommending transitions to be applied on the matched attribute pairs, outputting the recommended transitions as the results of matching the primary documents with the secondary documents on an interface of the client device 108.

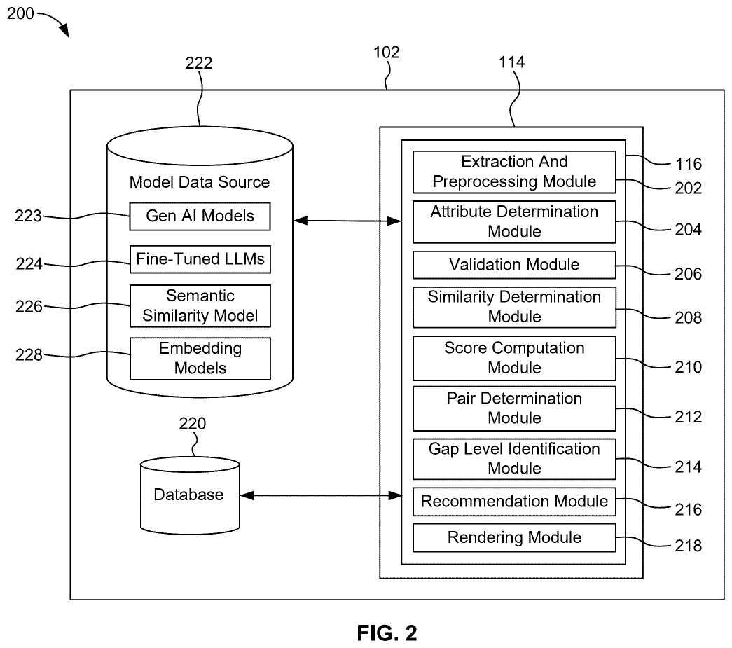

The memory 114 may also store various data (e.g., the input from the client device 108, the primary documents, the primary key attributes, the secondary key attributes, the ontology scores, the matched attribute pairs, the gap levels, the transitions, results of validating the primary key attributes and the secondary key attributes, and/or the like) that may be captured, processed, and/or required by the document processing system 102. Various examples of the document processing are described in conjunction with FIGS. 2-9.

FIG. 2 illustrates an example architecture 200 of the document processing engine 116 in the document processing system 102, for extracting and matching key attributes from documents, disclosed in the example environment of FIG. 1, for processing the documents, in accordance with implementations of the present disclosure. FIG. 2 is explained in conjunction with FIG. 1. As depicted in FIG. 2, to perform various operations of the document processing, the document processing engine 116 may include an extraction and preprocessing module 202, an attribute determination module 204, a validation module 206, a similarity determination module 208, a score computation module 210, a pair determination module 212, a gap level identification module 214, a recommendation module 216, and a rendering module 218.

The document processing engine 116 may be communicatively coupled to a database 220 for storing various data and/or intermediate results generated by the modules 202-218. The document processing engine 116 may store or extract the various data and/or intermediate results from the database 220 as per requirement. The document processing engine 116 may also be communicatively coupled to a model data source 222 (e.g., via the network 110). The model data source 222 may include Gen AI models 223, fine-tuned Large Language Models (LLMs) 224, a semantic similarity model 226, and embedding models 228. The Gen AI models 223 may include foundation models, LLMs, Artificial Intelligence (AI) models, Machine Learning (ML) models, and/or the like. The fine-tuned LLMs 224 may include LLMs that have been trained based on specific datasets to extract key attributes (e.g., the primary key attributes and the secondary key attributes) from the documents (e.g., the primary documents and the secondary documents). A non-limiting methodology for generating the fine-tuned LLMs 224 to extract the key attributes from the documents is disclosed in U.S. patent application Ser. No. 19/174,530, the disclosure of which is incorporated herein by reference in its entirety. The semantic similarity model 226 may be a cosine similarity model. The embedding models 228 may include Bidirectional Encoder Representations from Transformers (BERT) models, RoBeERTa models, and/or the like. The modules 202-216 of the document processing engine 116 may use the model data source 222 to perform the document processing, which is described in detail below.

The extraction and preprocessing module 202 may receive the primary documents from the data sources 104. The primary documents may include synthetic datasets and raw datasets. The synthetic datasets are typically computer-generated or simulated data that closely mimic real-world information, while the raw datasets include unprocessed, authentic data obtained directly from real-world sources. Examples of the synthetic datasets and raw datasets are already explained in detail in conjunction with FIG. 1, therefore repeated description is omitted herein for sake of brevity. The primary documents may include at least one of user demographic documents that provide detailed information about the user demographic data, user medical documents such as health records and medical histories, user legal documents which include contracts, compliance records, or legal proceedings, and user compliance documents which outline adherence to specific regulations, standards, or guidelines.

Further, the extraction and preprocessing module 202 may receive the secondary documents from the enterprise data sources 106. The secondary documents may include at least one of target demographic documents, target medical documents, target legal documents, and target compliance documents. As would be understood, the secondary documents may include other similar documents including the above-described examples. Some examples of target documents within the secondary documents are explained in conjunction with FIG. 1, therefore repeated description is omitted for the sake of brevity.

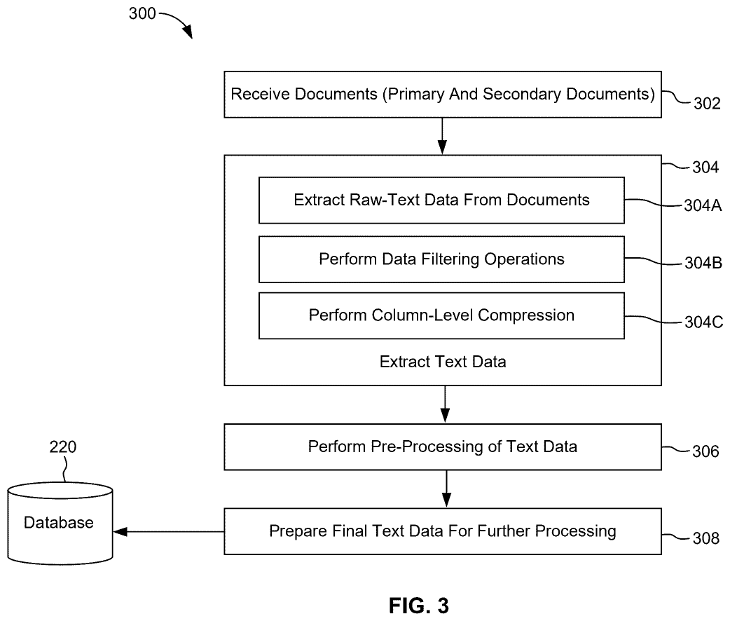

Once the primary documents and the secondary documents are extracted, the extraction and preprocessing module 202 may preprocess the primary documents and the secondary documents as these documents may be associated with structured formats, unstructured formats, semi-structured formats, or a combination thereof. In some examples, preprocessing the primary documents and the secondary documents may include extracting raw-text data from the primary documents and generating text data from the extracted raw-text data. The raw-text data may include raw data arranged in a free form or raw data in a form of tables. The raw-text data may be in an original text format. As a non-limiting example, the raw-text data may include unprocessed and unstructured text data. The text data may be generated by removing inappropriate/unnecessary data (e.g., metadata, footnotes, formatting tags), sensitive data, biased data, and/or the like. Generating the text data by preprocessing the respective primary documents or secondary documents is illustrated in detail in FIG. 3. The text data may be provided to the attribute determination module 204.

The attribute determination module 204 may extract primary key attributes from the primary documents. The primary key attributes may be extracted by processing the text data extracted from the primary documents using the fine-tuned LLMs 224. The fine-tuned LLMs 224 have been specifically trained to handle and extract key information (e.g., the primary key attributes) from different types of documents (e.g., the primary documents). The primary key attributes may include at least one of user demographic data, user qualification data, user medical data, user compliance data, and user proficiency level data. The qualification data may indicate job designations, skills, job summaries, a job experience dictionary, education, certifications, and/or the like. The medical data may indicate patient information, hospital information, symptoms, allergic details, medications, treatments and procedures, lab findings, historical medical conditions, and/or the like. The legal data may indicate laws, precedents, interpretations, clauses, agreements or contracts, and/or the like. The compliance data may indicate data protection policies, operational data requirements, and/or the like. The user proficiency level data may indicate a level of expertise of the respective users.

To extract the primary key attributes from the primary documents, the attribute determination module 204 may generate prompts for each of the primary documents based on the extracted respective text data. The prompts may include at least user defined instructions for extracting the primary key attributes. For example, if a primary document is a user demographic document (e.g., a resume), a prompt may be generated for extracting the primary key attributes such as extract qualifications, skills, and proficiency levels, and/or the like. The prompts guide the fine-tuned LLMs 224 to focus on specific areas of the primary documents, ensuring that the extracted primary key attributes are accurate and relevant to requirements. The attribute determination module 204 may use the fine-tuned LLMs 224 to extract the primary key attributes from the primary documents by processing the prompts.

In some implementations, the attribute determination module 204 may generate user proficiency level data using the extracted primary key attributes from the primary documents.

For generating the user proficiency level data, the attribute determination module 204 may identify key indicators associated with the primary key attributes. The key indicators may act as standard/default proficiency scales for the proficiency level determination. Non-limiting examples of the key indicators may include keywords/phrases, a period of usage value, and a frequency of occurrence of the extracted primary key attributes. The attribute determination module 204 may apply Natural Language Processing (NLP) techniques, such as named entity recognition (NER), part-of-speech tagging, and dependency parsing, on the primary key attributes to identify the keywords/phrases such as verbs denoting experience (e.g., “developed”, “implemented”, and/or the like), time expressions indicating usage duration (e.g., “3 years”, “since 2020”, and/or the like), and/or descriptive qualifiers (e.g., “expert”, “proficient”, “basic”, and/or the like). The attribute determination module 204 may identify the period of usage value of each of the primary key attributes, based on the identified predefined keywords. The attribute determination module 204 may identify the frequency of occurrence of each of the primary key attributes, based on the identified period usage value. For example, if the primary key attributes include the qualification data, the keywords/phrases may include “advanced Java programming”, “extensive experience with Java”, “expertise in Java”, and/or the like. The period of usage value may indicate dates of employment associated with skills in the qualification data. By way of non-limiting example, the dates of employment (e.g., a start date, an end date, and/or the like) may provide information about utilization of the skills during a period of time. The frequency of occurrence may indicate a number of occurrences related to the skills in the qualification data.

Based on the identified key indicators, the attribute determination module 204 may generate a graphical representation of the primary key attributes. As a non-limiting example, the graphical representation may include a structured format of representation. By way of non-limiting example, the structured format of representation may include a JavaScript Object Notation (JSON) format. The attribute determination module 204 may identify the similarity between the primary key attributes, based on the generated graphical representation and using the embedding models 228. The attribute determination module 204 may create a clustered data by clustering the similar primary key attributes into cluster groups. The attribute determination module 204 may create an aggregated data by aggregating the period of usage value (identified in the key indicators) of each of the primary key attributes in the created clustered data. Further, the attribute determination module 204 may determine the proficiency level of each of the primary key attributes, based on the aggregated data. Based on the proficiency level of each of the primary key attributes, the attribute determination module 204 may generate the user proficiency level data. The user proficiency level data may correspond to a dataset including a proficiency level of each of the primary attributes. The proficiency level of each of the primary attributes may correspond to a level of expertise associated with a respective user. The proficiency level may include one or more of: a beginner level, an intermediate level, an advanced level, a master level, and an expert level.

Further, the attribute determination module 204 may extract the secondary key attributes from the secondary documents. The secondary key attributes may be extracted by processing the text data (generating from the secondary documents), using the fine-tuned LLMs 224. The secondary key attributes include at least one of target demographic data, target qualification data, target medical data, and target compliance data, and target proficiency level data. In some examples, the attribute determination module 204 may generate prompts based on the text data of the secondary documents and provide the prompts to the fine-tuned LLMs 224 to extract the secondary key attributes from the secondary documents.

In some examples, after extracting the secondary key attributes from the secondary documents, the attribute determination module 204 may determine target proficiency level data corresponding to the secondary key attributes. For generating the target proficiency level data, the attribute determination module 204 may identify primary key words in the text data of the secondary documents. The primary key words correspond to the secondary key attributes including a highest priority level. The secondary key attributes including the highest priority level may indicate mandate key attributes to be present in the secondary key attributes. For example, if the secondary key attributes include qualification data, the mandate key attributes may include “must have skills”, “good to have skills”, or any other skills that may be additional to have skills using an open-source LLM. Further, the attribute determination module 204 may identify proficiency indicators in the text data of the secondary documents. The proficiency indicators correspond to secondary key words indicating the proficiency level of each of the secondary key attributes. The attribute determination module 204 may further determine a proficiency level of the secondary key attributes, based on the primary key words, and the proficiency indicators. In an example, the proficiency level may indicate an expertise level associated with the secondary key attributes. Based on the proficiency level, the attribute determination module 204 may generate the target proficiency level data. The target proficiency level data may correspond to a dataset including the proficiency level of the secondary key attributes.

The validation module 206 may validate the primary key attributes, and the secondary key attributes, using the fine-tuned LLMs 224. The validation module 206 may further store the validated primary key attributes and the associated graphical representation in the database 220. Storing only the validated primary key attributes in the database 220 instead of all the primary key attributes may improve utilization of a storage space in the database 220, reduce data leakage by mitigating exposure risk associated with the personal data present in the primary documents, and ensure improved processing of the primary key attributes by maintaining minimal data (only the successfully validated primary key attributes) in the database 220. Further, the database 220 may ensure data integrity and enable efficient querying of the primary key attributes.

To validate the primary key attributes, and the secondary key attributes, the validation module 206 may perform a standardization process. To perform the standardization process, the validation module 206 may identify a semantic pair for each of the primary key attributes, and each of the secondary key attributes. In some examples, for identifying the semantic pair, the validation module 206 may apply a semantic search technique on a domain specific skill repository (also referred to as base repository) and identify the semantic pair for each of the primary key attributes and the secondary key attributes. The domain specific skill repository may include different pairs of key attributes, which have been curated as a base knowledge source of multi-industry and multi-domain attributes. The different pairs of key attributes in the domain specific skill repository may be curated by mining the various data sources 104 that include the key attributes classified with respective labels. In some examples, the domain specific skill repository may include the different pairs of key attributes in a form of base index files (e.g., indexed version of key attribute embeddings). Therefore, the semantic pair may provide the key attributes for each of the primary key attributes and the secondary key attributes with the nearest proximity. Further, the semantic pair may include a key attribute from the primary key attributes and a respective matching key attribute from the secondary key attributes. By way of non-limiting example, the semantic pair may include a skill from the primary key attributes and a respective matching skill from the secondary key attributes.

Upon identifying the semantic pair, the validation module 206 may compare the semantic pair with a semantic threshold value (e.g., a second predefined threshold value). Based on the comparison, the validation module 206 may determine delta key attributes and validated key attributes, of the semantic pair. The delta key attributes may correspond to the semantic pair failing to exceed the semantic threshold value. The validated key attributes may correspond to the semantic pair exceeding the semantic threshold value. The validation module 206 may determine key attribute data, based on the delta key attributes, and the validated key attributes. The key attribute data may provide a description (e.g., a synthetic description or a short description) corresponding to a combination of the delta key attributes, and the validated key attributes. In some examples, the key attribute data may be determined using LLMs. The validation module 206 may identify similarity between each of the delta key attributes, and each of the validated key attributes, within the key attribute data. Based on the identified similarity, the validation module 206 may determine key attributes, from the delta key attributes and the validated key attributes, having the similarity (hereinafter referred to as similar key attributes). The validation module 206 may further create a final attribute dataset by filtering the similar key attributes from the key attribute data, based on the identified similarity. The final attribute dataset may provide a description for each of the key attributes resultant from filtering of the similar key attributes from the delta key attributes and the validated key attributes. The validation module 206 may provide results of the validation that is the final attribute dataset to the similarity determination module 208.

The similarity determination module 208 may determine a similarity between the primary key attributes, and the secondary key attributes based on the results of validation (e.g., the final attribute dataset).

To determine the similarity between the primary key attributes, and the secondary key attributes, the similarity determination module 208 may generate a primary description data for the primary key attributes and a secondary description for the secondary key attributes based on the final attribute dataset. The primary description data may correspond to a detailed textual description of each of the primary key attributes. The secondary description data may correspond to a detailed textual description of each of the secondary key attributes. In some examples, the similarity determination module 208 may generate the primary description data and the secondary description using one of the Gen AI models 223. To illustrate, the similarity determination module 208 may generate a series of prompts using the final attribute dataset resultant from the validation and through a Chain of Thought (COT) prompting techniques. The COT prompting techniques and the final attribute dataset may enable one of the Gen AI models to learn core responsibilities and required key attributes, contextualize learned core responsibilities and required key attributes within a specific domain, and finally generate the primary description and the secondary description for the primary documents and the secondary documents, respectively. In some other examples, the similarity determination module 208 may generate the primary description data and the secondary description using one of the fine-tuned LLMs 224.

The similarity determination module 208 may further generate primary attribute embeddings by converting the primary description data into a vector embedded representation, using the embedding models 228. Similarly, the similarity determination module 208 may generate secondary attribute embeddings by converting the secondary description data into the vector embedded representation, using the embedding models 228.

The similarity determination module 208 may compare the generated primary attribute embeddings with the generated secondary attribute embeddings. To compare the generated primary attribute embeddings with the generated secondary attribute embeddings, the similarity determination module 208 may pre-process the generated primary description data, and the secondary description data by filtering external attributes from the primary description data, and the secondary description data. The external attributes may include one or more of non-American Standard Code for Information Interchange (ASCII) values, special characters, Hyper-Text Markup Language (HTML) tags, stop words, punctuation, and unwanted characters. The similarity determination module 208 may convert the pre-processed primary description data, and the secondary description data into tokenized inputs relevant to the embedding models 228, thereby generating the tokenized inputs. For generating the tokenized inputs, the similarity determination module 208 may split the primary description data and the secondary description data into respective tokens (e.g., words) and generate the tokenized inputs for the respective tokens. The tokenized inputs may indicate indexed versions or numerical representations of tokens (e.g., words) in the preprocessed primary description data and the secondary description data. The similarity determination module 208 may process the tokenized inputs using the embedding models 228 to generate token embeddings. In some examples, the token embeddings may be generated using an embedding layer and transformer blocks of the embedding models 228. The token embeddings may indicate vector representations of the tokenized inputs.

Based on the token embeddings, the similarity determination module 208 may compute sentence embeddings and convert the sentence embeddings into a data frame. The data frame may include the primary attribute embeddings and the secondary attribute embeddings in a form of rows and columns. The similarity determination module 208 may compare the generated primary attribute embeddings with the generated secondary attribute embeddings, based on the created data frame. In some examples, the similarity determination module 208 may compare the generated primary attribute embeddings with the generated secondary attribute embeddings using similarity-based techniques such as cosine similarity, Jaccard similarity, or any other distance metrics. Based on the comparison, the similarity determination module 208 may determine the similarity between the primary attribute embeddings and the secondary attribute embeddings, thereby determining the similarity between the primary key attributes and the secondary key attributes. The similarity determination module 208 may provide the determined similarity between the primary key attributes and the secondary key attributes to the score computation module 210.

The score computation module 210 may compute ontology scores (which may also be referred to as proximity scores) for each of the primary key attributes and the secondary key attributes, based on the determined similarity. The ontology scores may correspond to a similarity level between the primary key attributes, and the secondary key attributes. To compute the ontology scores for each of the primary key attributes and the secondary key attributes, the score computation module 210 may determine an angle of similarity between attribute embeddings associated with the primary key attributes, and secondary attribute embeddings associated with the secondary key attributes. The score computation module 210 may determine an orientation of the primary attribute embeddings relative to the secondary attribute embeddings, based on the determined angle of similarity. Further, the score computation module 210 may compute the ontology scores for each of the primary key attributes and the secondary key attributes, based on the determined orientation. The ontology scores computed for each of the primary key attributes and the secondary key attributes may be provided to the pair determination module 212.

The pair determination module 212 may determine matched attribute pairs. The matched attribute pair may refer to a pair of key attributes that have been matched, wherein the pair of key attributes may include a key attribute from the primary key attributes and a respectively matched key attribute from the secondary key attributes.

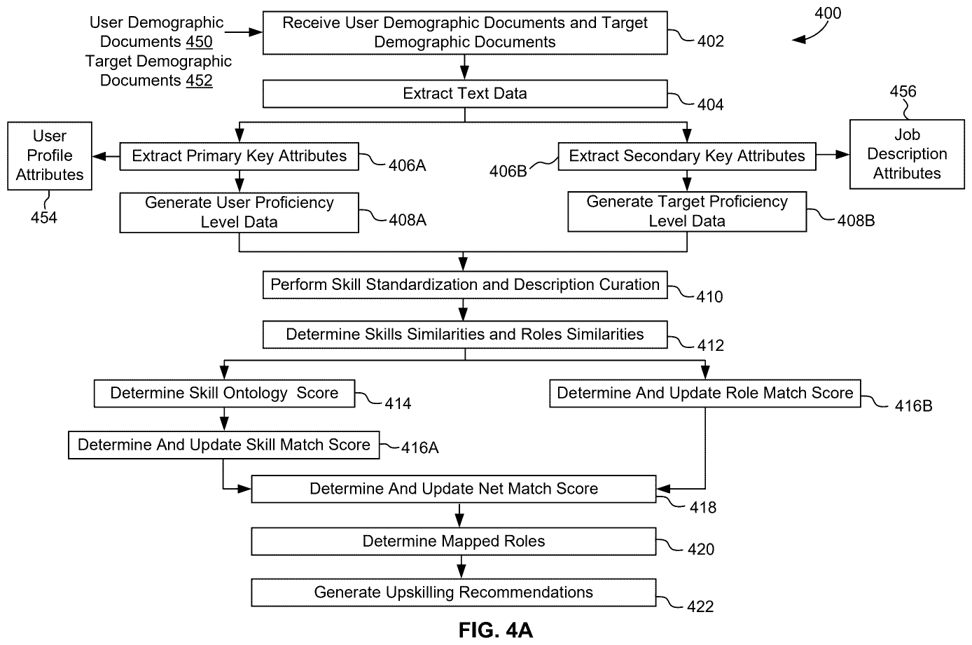

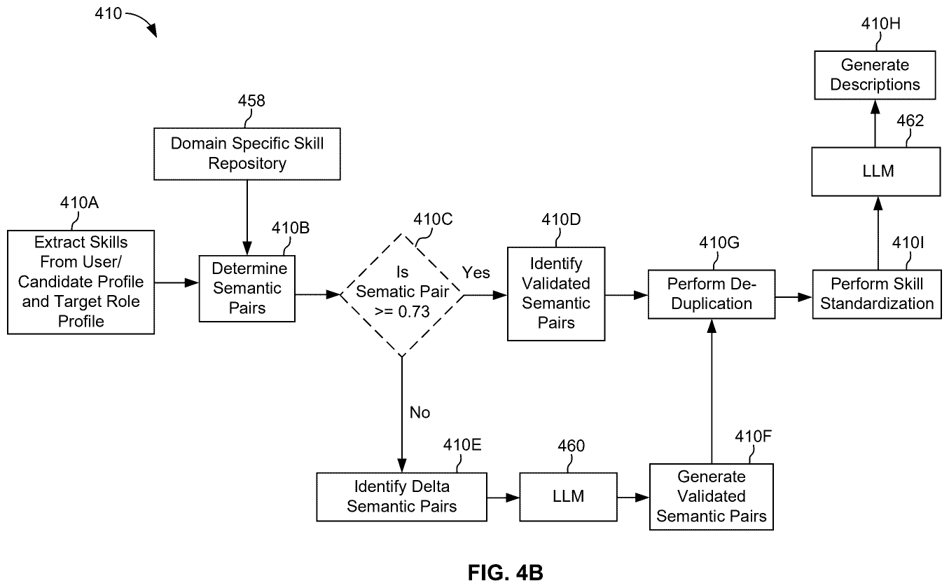

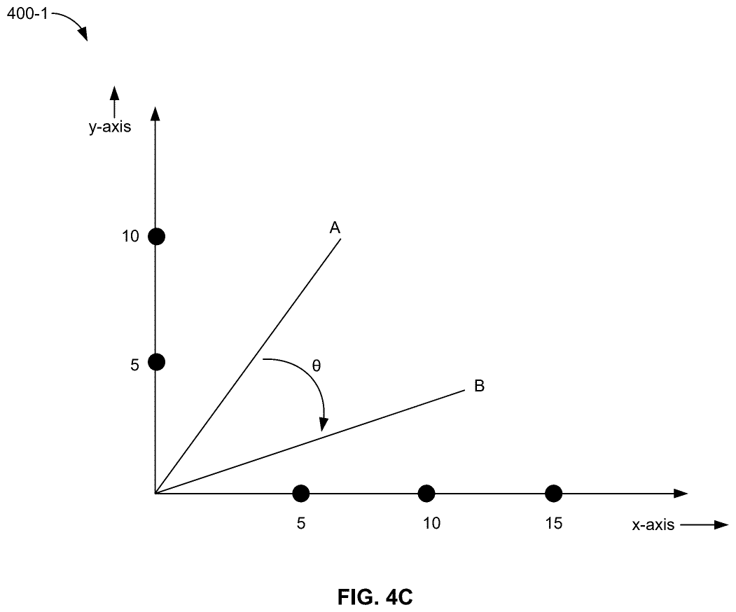

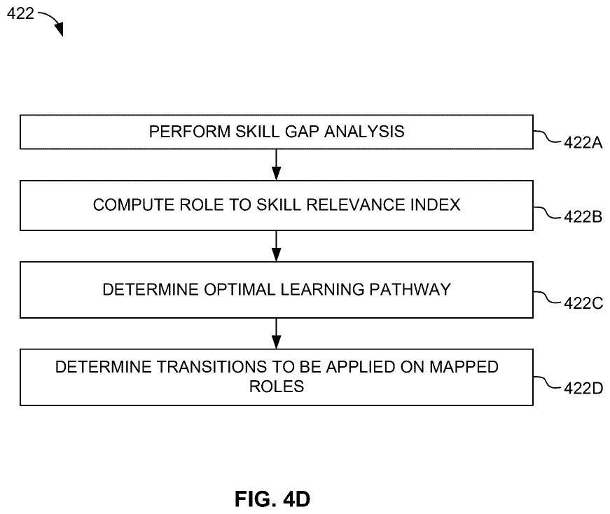

To determine the matched attribute pairs, the pair determination module 212 may determine a primary match score for each pair of the primary key attributes and the secondary key attributes, based on a weighted average of the computed ontology scores. The pair determination module 212 may compare each primary match score with first, second, third, and fourth score threshold values (e.g., 75%, 50%-75%, 35%-50%, and 35%, respectively). If the primary match score is greater than the first score threshold value (e.g., 75%), the pair determination module 212 may determine that the respective pair of primary key attribute and the secondary key attribute may be a high proximity attribute pair. In such a scenario, the pair determination module 212 may update the primary match score (e.g., increases the primary match score by 5%) based on various factors including at least one of a relevancy factor, a proficiency delta value, an alignment value, a minimum proximity threshold value, and a proximity percentage value (described in detail in conjunction with FIG. 4A). If the primary match score is between the second score threshold value (e.g., between 50% and 75%), the pair determination module 212 may determine to retain the primary match score without any changes. If the primary match score is between the third score threshold value (e.g., between 35% and 50%) or below the fourth score threshold value (e.g., less than 35%), the pair determination module 212 may update the primary match score (e.g., decreases the primary match score by 10% and 20%, respectively), based on various factors including at least one of a relevancy factor, a proficiency delta value, an alignment value, a minimum proximity threshold value, and a proximity percentage value.

Based on each primary match score, the pair determination module 212 may generate a net match score for each pair of the primary key attributes and the secondary key attributes. The net match score may be generated based on the primary match score or the updated primary match score of the respective pair of the primary key attributes and the secondary key attributes.

After generating the net match score for each pair of the primary key attributes and the secondary key attributes, the pair determination module 212 may identify a mismatch between attribute levels of the primary key attributes and the secondary key attributes. For identifying the mismatch between the attribute levels of the primary key attributes and the secondary key attributes, the pair determination module 212 may identify attribute levels associated with the primary key attributes and the secondary key attributes. The attribute levels associated with the primary key attributes/secondary key attributes may be determined based on the extracted respective primary key attributes/secondary key attributes as well as a context of the enterprise (e.g., functions of the enterprise, domains related to the enterprise, and/or the like). In an example, if the primary key attributes relate to the qualification data and the secondary key attributes relate to the target qualification data, the pair determination module 212 may identify the attribute levels associated with the primary key attributes and the secondary key attributes such as an entry-level, a mid-level, a senior-level, a leadership-level, and/or the like. Once the attribute levels are identified, the pair determination module 212 may identify the mismatch between the respective attribute levels. In an example, the identified mismatch may include one of: a severe mismatch, a moderate mismatch, and an exact or near mismatch. If the attribute levels identified with the secondary key attributes are two or more levels above or below the attribute levels identified with the primary key attributes, the pair determination module 212 may identify the severe mismatch. If the attribute levels identified with the secondary key attributes are one level below the attribute levels identified with the primary key attributes, the pair determination module 212 may identify the moderate mismatch. If the attribute levels identified with the secondary key attributes are one level above or match with the attribute levels identified with the primary key attributes, the pair determination module 212 may identify the exact or near mismatch.

Once the mismatch between the attribute levels of the primary key attributes and the secondary key attributes are identified, the pair determination module 212 may update the net match score for each pair of the primary key attributes and the secondary key attributes. In an example, if the mismatch includes the severe mismatch, the pair determination module 212 may update the net match score for the respective pair of the primary key attributes and the secondary key attributes by reducing the net match score by 50%. If the mismatch includes the moderate mismatch, the pair determination module 212 may update the net match score for the respective pair of the primary key attributes and the secondary key attributes by reducing the net match score by 10%. If the mismatch includes the exact or near mismatch, the pair determination module 212 may does not update the net match score for the respective pair of the primary key attributes and the secondary key attributes.

Based on the net match score of each pair of the primary key attributes and the secondary key attributes, the pair determination module 212 may determine the matched attribute pairs. Each matched attribute pair may include a key attribute from the primary key attributes and a respectively matched key attribute from the secondary key attributes.

Additionally, or alternatively, the pair determination module 212 may update the fine-tuned LLMs 224 (which have been used for extracting the primary key attributes and the secondary key attributes) by continuously training the fine-tuned LLMs 224 based on results of determination of the matched attribute pairs. The pair determination module 212 may also provide the matched attribute pairs to the gap level identification module 214.

The gap level identification module 214 may identify a gap level between each of the determined matched attribute pairs using the fine-tuned LLMs 224. The gap level may correspond to a gap in a similarity level between the determined matched attribute pairs.

To identify the gap level, the gap level identification module 214 may determine baseline attributes and low-grade attributes based on the ontology scores. The gap level identification module 214 may compare the ontology scores computed for each of the primary key attributes and the secondary key attributes included in the respective matched attribute pairs with an ontology score threshold value (e.g., first predefined threshold value). The gap level identification module 214 may determine the key attributes from each of the primary key attributes and the secondary key attributes as the baseline attributes, if the respective ontology scores exceeds the ontology score threshold value. The baseline attributes may refer to similar key attributes including the primary key attributes that are same or having similar representation with the respective secondary key attributes. The gap level identification module 214 may determine the key attributes from each of the primary key attributes and the secondary key attributes as the low-grade attributes, if the respective ontology scores fail to meet the ontology score threshold value. The low-grade attributes may refer to similar key attributes including the primary key attributes that are not same or not having similar representation with the respective secondary key attributes.

The gap level identification module 214 may compare the baseline attributes with the low-grade attributes. Based on the comparison, the gap level identification module 214 may identify the gap level between the baseline attributes, and the low-grade attributes. The identified gap level may be provided to the recommendation module 216.

The recommendation module 216 may recommend transitions to be applied to each of the matched attribute pairs, based on the identified gap level. The transitions may include performing modifications to the matched attribute pairs, to match with the ontology score threshold value.

For recommending the transitions, the recommendation module 216 may compute a relevance index value for each secondary key attribute with respect to another secondary key attribute included in all the determined matched attribute pairs. Therefore, the relevance index value may determine how much each secondary key attribute is relevant to other attributes. By way of non-limiting example, if the secondary key attributes extracted from the target demographic documents include target roles and target skills, then the relevance index value may be computed as a role-to-skill relevance index value that may determine how much each target role is relevant to each target skill. The recommendation module 216 may compute the relevance index value based on at least one of a demand factor, a market trend factor, and a prioritization factor. The demand factor may identify a total demand associated with each of the secondary key attributes. The market trend factor may be identified based on third party available data and insights received from external sources, the primary key attributes extracted from the primary documents, and the secondary key attributes extracted from the secondary documents.

Once the relevance index value is computed for each of the secondary key attributes included in the matched attribute pairs, the recommendation module 216 may determine an optimal learning pathway data. The optimal learning pathway data may be determined based on a weighted average of the computed relevance index value, and each of the computed ontology scores. In an example, the optimal learning pathway data include at least one of the matched attribute pairs to be updated, sorted in a descending order of the computed relevance index value. In another example, the optimal learning pathway data include at least one of the similar matched attribute pairs sorted in the descending order of the computed relevance index value.

Further, the recommendation module 216 may recommend the transitions to be applied for each of the matched attribute pairs, based on the determined optimal learning pathway data. The recommended transitions may be provided to the rendering module 218. The rendering module 218 may output the recommended transitions on an interface of the client device 108 and/or a user interface of a user device (not shown).

FIG. 3 depicts an exemplary flow diagram presenting a method 300 for receiving and preprocessing the primary documents and the secondary documents, in accordance with implementations of the present disclosure. In some implementations, the method 300 may be executed by the processor 112 of the document processing system 102 using the document processing engine 116, as described in relation to FIGS. 1 and 2. It should be noted that FIG. 3 is described by collectively referring to the primary documents and the secondary documents as documents.

At step 302, the method 300 includes receiving the documents (the primary and/or secondary documents) using suitable data mining techniques. In some examples, the documents may include the data in various formats. By way of non-limiting example, the documents may include structured data, unstructured data, a semi-structured data, and/or a combination thereof. The structured data may include data files derived from Structured Query Language (SQL) databases, excel files/spreadsheets, web forms, and/or the like. The unstructured data may include text files of various types (e.g., word files, Portable Document Format (PDF) files), image files of various types (e.g., a Joint Photographic Experts Group (JPEG) format, a Portable Network Graphic (PNG) format, a Graphic Interchange Format (GIF) format, and/or the like), video files, emails, presentations, social media posts, and/or the like. The semi-structured data may include Hyper-Text Markup Language (HTML) codes, Extensible Markup Language (XML) data, and/or a combination thereof.

At step 304, the method 300 includes extracting the text data from the documents.

For extracting the text data, at step 304A, the method 300 includes extracting the raw-text data from the documents. The raw-text data may include raw data arranged in a free form or raw data in a form of tables including rows and columns. The raw-text data may be in an original text format. As a non-limiting example, the raw-text data may include unprocessed and unstructured text data. In some examples, the raw-text data may be extracted using a suitable text extraction library.

At step 304B, the method 300 includes performing data filtering operations on the extracted raw-text data to remove inappropriate or unnecessary data from the raw-text data. In some examples, the inappropriate or unnecessary data may include metadata, footnotes, formatting tags, duplicate data, sensitive data, biased data, and/or the like. After performing the data filtering operations on the raw-text data, large text fields and short text/numerical/date fields may be arranged in a form of separate/individual tables including the rows and the columns.

At step 304C, the method 300 includes performing column-level compression on the columns of the tables (corresponding to the large text fields and short text/numerical/date fields), thereby extracting the text data from the documents. In some examples, the column-level compression may be performed based on a type and a pattern of the raw-text data extracted from the documents. The text data may correspond to data resultant from performing the filtering operations and the column-level compression on the raw-text data. Such an extraction of the text data may reduce a storage space required to store the documents and improve performance of the prompts that may be generated for extracting key attributes (e.g., the primary key attributes and the secondary key attributes) from the documents.

At step 306, the method 300 includes performing pre-processing of the text-data. In some examples, pre-processing of the text data may include arranging the text data in a number of predefined batches, performing memory transformations, and streamlining data transformation operations. Arranging the text data in the number of predefined batches may eliminate a need to store the text-data entirely into the database 220 or the memory 114. Performing the memory transformations may avoid storing intermediate results to the database 220 or the memory 114. The data transformation operations may be streamlined using, for example, Spark framework. Streaming the data transformation operations may enable further processing of the text data on the fly/dynamically and in batches, which may improve scalability while reducing utilization of computing resources (e.g., memory footprint and storage) for processing of the text data.

At step 308, the method 300 includes preparing final text data based on pre-processing of the text data. The final text data may correspond to the preprocessed text data, which may be used for further processing. The final text data may be stored in the database 220 in a compressed format (e.g., Parquet). Storing only the final text data in the database 220 instead of the entire documents may improve utilization of a storage space in the database 220, reduce data leakage by mitigating exposure risk associated with the sensitive data in the documents, and ensure improved processing of the text data by maintaining minimal data in the database 220. Further, the database 220 may ensure data integrity and enable efficient querying of the text data. In addition, the database 220 may provide A tomicity, Consistency, Isolation, and Durability (ACID) transaction logs associated with querying of the text data and streaming of the text data in the predefined number of batches.

FIG. 4A depicts an exemplary flow diagram presenting a method 400 for processing the primary and the secondary documents, in accordance with implementations of the present disclosure. In some implementations, the method 400 may be executed by the processor 112 of the document processing system 102 using the document processing engine 116, as described in relation to FIGS. 1 and 2. Implementations of the present disclosure are described in detail in FIG. 4 by considering the primary documents and the secondary documents as user demographic documents 450 and target demographic documents 452, respectively, however it may be obvious to a person skilled in the art that any other similar documents (legal documents, compliance documents, and/or the like) may be considered for processing. Non-limiting examples of the user demographic documents 450 and the target demographic documents 452 may include resumes/qualification documents and job descriptions, respectively.

At step 402, the method 400 includes receiving the user demographic documents 450 from the data sources 104 and the target demographic documents 452 from the enterprise data sources 106 (depicted in FIG. 1). The user demographic documents 450 and the target demographic documents 452 may be received for processing upon receiving a document processing request from the client device 108 associated with the enterprise. The document processing request may indicate documents to be processed, and/or the application/domain for which the documents to be processed, and key attributes to be extracted from processing of the indicated documents.

At step 404, the method 400 includes extracting the text data from the user demographic documents 450 and the target demographic documents 452. Extraction of the text data is described in detail along with the exemplary method 300 of FIG. 3, therefore repeated description is omitted herein for sake of brevity.

At step 406A, the method 400 includes extracting primary key attributes from the user demographic documents 450. In some examples, for extracting the primary key attributes, prompts may be generated based on the text data extracted from the user demographic documents 450. The prompts may include one or more user defined instructions for extracting the primary key attributes. The prompts and the text data extracted from the user demographic documents 450 may be provided to one of the fine-tuned LLMs 224, which may extract the primary key attributes. In some other examples, the primary key attributes may be extracted using ML models, semantic search-based techniques, and/or the like. The primary key attributes may include user profile attributes 454. Each user profile attribute of the user profile attributes 454 may include information or details such as role title, experiences with date span, skills (including domain specific skills as well as contextual skills), education, certifications, profile summary, and/or the like.

At step 406B, the method 400 includes extracting secondary key attributes from the target demographic documents 452. In some examples, for extracting the secondary key attributes, prompts may be generated based on the text data extracted from the target demographic documents 452. The prompts may include one or more user defined instructions for extracting the secondary key attributes. The prompts and the text data extracted from the target demographic documents 452 may be provided to one of the fine-tuned LLMs 224, which may extract the secondary key attributes. In some other examples, the secondary key attributes may be extracted using ML models, semantic search-based techniques, and/or the like. The secondary key attributes may include job description attributes 456. Each job description may include information or details such as target job roles/open job roles, skills required for the target job roles, job/qualification mandates, and/or the like.

Once the user profile attributes 454 and the job description attributes 456 are extracted, at step 408A, the method 400 includes generating the user proficiency level data with respect to the user demographic documents 450. The user proficiency data may indicate a proficiency level associated with each of the skills present in the respective user profile attribute 454. For generating the user proficiency level data, the document processing engine 116 may identify the experiences with data span from the respective user profile attribute and determine period of usage values associated with the skills in the experiences with date span. The document processing engine 116 may convert the period of usage values into proficiency labels and generate the user proficiency data by determining proficiency levels for the skills using a skill approximation technique. By way of non-limiting example, the user proficiency data may include the skills and the associated proficiency levels.

At step 408B, the method 400 includes generating target proficiency level data with respect to the target demographic documents 452. The target proficiency level data may indicate a proficiency level associated with each of the skills present in the respective job description.

For generating the target proficiency level data, the document processing engine 116 may identify primary key words/context associated with the required skills included in the job description attribute and classify the required skills into one or more categories. If the required skills included in the job description attributes are associated with the primary key words/context such as “Must Have”, “Good to Have”, “Additional”, and/or similar words/phrases, the document processing engine 116 may use any LLM to classify the required skills into categories based on their context in the job description attributes. In some examples, the document processing engine 116 may use a few-shot COT prompting to generate prompts for the LLM based on contexts/key words present in pre-selected reference job description attributes. Exemplary contexts may include:

Must Have Skills: Essential for the role, often indicated by phrases like “required”, “must have” or “essential.”

Good to Have Skills: Beneficial but not critical, indicated by terms like “preferred”, “nice to have”, “familiar with” or “desirable.”

Additional Skills: Supplementary skills that enhance a candidate's profile, often mentioned in a less formal context.

Upon classifying the required skills into the categories, the document processing engine 116 may identify proficiency indicators in the job description attributes. Exemplary proficiency indicators may include:

Beginner: “used”, “having the knowledge of′, “used tools like”, at least 1 year of experience”.

Intermediate: “experienced in”, “more than 2 years of experience in”, “developed using”, “certified in”, “built using”, “hands on experience with”, “good understanding of”.

Advanced: “strong foundation”, “specialist in using”, “expertise in”, “in depth knowledge of”′, “extremely skilled in”, “more than 5 years of experience”, “proven record of”, “build end to end”, “implemented using”, “subject matter expert”, “highly specialized in”, “excellent understanding of”.

Based on the classified required skills and the proficiency indicators, the document processing engine 116 may determine proficiency levels/labels for the required skills. In some examples, a proficiency level may include one or more of: a beginner level, an intermediate level, an advanced level, a master level, and an expert level. Based on the proficiency levels/labels for the required skills, the document processing engine 116 may generate the target proficiency level data. An exemplary table illustrating the proficiency level data is depicted below:

TABLE 1
Target Proficiency Level Data

| | | Proficiency | Proficiency |
|---|---|---|---|
| Context | Skills | Indicators | Level |
| We are looking for a | Python | Proficient | Advanced |
| data scientist proficient | Machine | Must Have | Advanced |
| in Python and Databricks ML. | Learning | | |
| Experience with machine | Hadoop | Preferred | Intermediate |
| learning & NLP algorithms | Databricks | Proficient | Advanced |
| is a must. Familiarity with | NLP | Must have | Advanced |
| big data tools like Hadoop & | Apache | Preferred | Intermediate |
| Apache Spark is a plus. | Spark | | |

If the job description attributes do not include sufficient context (e.g., the required skills, the proficiency indicators, and/or the like), the document processing engine 116 may use approximation technique to generate the target proficiency level data. The document processing engine 116 may receive pre-existing job description attributes stored in the database 220, extract the required skills from the pre-existing job description attributes, and apply the approximation technique on the required skills in the pre-existing job description attributes and the job description attributes to generate the proficiency level data. The pre-existing job description attributes may include skill sets related to the various domains/industries. The approximation technique may include an approximation rule to generate the proficiency level data. An exemplary approximation rule may include:

{″role_technical″: {″entry-level″: {″skill_technical″: ″Intermediate″, ″skill_domain/functional″:
″Beginner″, ″skill_leadership″: ″Beginner″},
″mid-level″: {″skill_technical″:″Advanced″, ″skill_domain/functional″: ″Intermediate″,
″skill_leadership″:″Beginner″},
″senior-level″:{″skill_technical″:″Advanced″, ″skill_domain/functional″: ″Intermediate″.
″skill_leadership″:″Intermediate″},
″leadership-level″:{″skill_technical″:″Advanced″, ″skill_domain/functional″: ″Advanced″,
″skill_leadership″:″Advanced″}},
″role_functional″:{″entry-level″:{″skill_technical″:″Beginner″, ″skill_domain/functional″:
″Intermediate″, ″skill_leadership″:″Beginner″},
″mid-level″:{″skill_technical″; ″Intermediate″, ″skill_domain/functional″: ″Advanced″,
″skill_leadership″: ″Beginner″},
″senior-level″:{″skill_technical″: ″Intermediate″, ″skill_domain/functional″: ″Advanced″,
″skill_leadership″:″Advanced″},
″leadership-level″:{″skill_technical″: ″Intermediate″, ″skill_domain/functional″:″Advanced″,
″skill_leadership″:″Advanced″}},
″role_creative″: {″entry-level″: {″skill_technical″: ″Beginner″ , ″skill_domain″: ″Beginner″,
″skill_creative,″: ″Intermediate″},
″mid-level″: {″skill_technical″:″Intermediate″ ″skill_domain″:″Intermediate″,
″skill_creative,″:″Advanced″},
″senior-level″:{″skill_technical″:″Intermediate″, ″skill_domain″:″Advanced″,
″skill_creative,″:″Advanced″},
″leadership-level″:{″skill_technical″:″Intermediate″, ″skill_domain″:″Advanced″,
″skill_creative,″:″Advanced″}

In an example, if the job description attributes include an entry-level technical role in data and AI department, the target proficiency level data may include an intermediate level in foundational technical skills, a beginner level in domain specific skills, a beginner level in soft/personal leadership skills. In another example, if the job description attributes include senior managerial role in finance department, the target proficiency level data may include an advanced level in leadership and strategic planning skills, an intermediate level in relevant technical skills, and an advanced level in core finance skills.

At step 410, the method 400 includes performing skill standardization and description curation, which is described in detail in conjunction with FIG. 4B.

As depicted in FIG. 4B, at step 410A, the method 400 includes extracting the skills from the user profile attributes 454 and the job description attributes 456, respectively. The skills may include implicit skills and explicit skills. The explicit skills may refer to skills that are directly mentioned or listed in the user profile attributes 454 and the job description attributes 456. For example, the explicit skills may be associated with the keywords such as “Python programming”, “Project Management”, “Data Analysis” and/or the like. The implicit skills may refer to skills that are not explicitly listed but may be inferred from content (e.g., such as through experience or achievements) of the user profile attributes 454 and the job description attributes 456, respectively. For example, a phrase like “leading a team on data project” may be implicitly inferred that a user/candidate possesses skills such as “Project Management”, “Leadership”, and/or the like.

At step 410B, the method 400 includes identifying semantic pairs for the skills extracted from the user profile attributes 454 and the job description attributes 456. The document processing engine 116 may map the extracted skills with skills present in a domain specific skill repository 458 and identify the semantic pairs for the skills. The domain specific skill repository 458 may be a curated repository including multi-industry and multi-domain skill-terms. The domain specific skill repository 458 may be generated by gathering data from a variety of labor market data providers, as well as internal skill dictionaries managed by the enterprise. The domain specific skill repository 458 may provide classified labels and skill-terms which serve as standardized representation for skills across multiple industries. The domain specific skill repository 458 may include multi-industry and multi-domain skill-terms in a form of indexed skill embeddings. The indexed skill embeddings are mathematical representations of skills that capture meanings of the skills in a high-dimensional vector space.

At step 410C, the method 400 includes comparing the semantic pairs with the semantic threshold value (e.g., the second predefined threshold value). In an example, the semantic threshold value may be predefined as 0.75. If any of the semantic pairs exceeds or equal to the semantic threshold value, at step 410D, the method 400 includes identifying such semantic pairs as validated semantic pairs (e.g., validated key attributes). If any of the semantic pairs fail to meet the semantic threshold value, at step 410E, the method 400 includes identifying such semantic pairs as delta semantic pairs (e.g., delta key attributes). At step 410F, the method 400 includes generating the validated semantic pairs by processing the delta semantic pairs using an LLM 460. The validated semantic pairs may be generated by validating whether the delta semantic pairs represent the skills or not. A combination of the semantic pairs exceeding or equal to the semantic threshold value and the generated validated semantic pairs using the LLM 460 may form standardized skill population corresponding to the user profile attributes 454 and the job description attributes 456.

At step 410G, the method 400 includes performing de-duplication on the standardized skill population to filter duplicate skills/redundant representation of skills through semantic comparison of each skill with other skills within the standardized skill population.

At step 410H, the method 400 includes performing skill standardization to standardize phrases or words associated with the skills in the de-duplicated standardized skill population. The skill standardization may be performed by matching the de-duplicated standardized skill population with descriptions provided for the skills in the domain specific skill repository 458, thereby normalizing the phrases or words associated with the skills into a standard nomenclature.

After performing the skill standardization, at step 4101, the method 400 includes generating/curating descriptions for the user profile attributes 454 and the job description attributes 456 including the standardized skills. The descriptions may include synthetic short descriptions for each attribute (including the standardized skills) in the user profile attributes 454 and the job description attributes 456. In some examples, an LLM 462 may be used to generate the descriptions for the user profile attributes 454 and the job description attributes 456. By way of non-limiting example, a description generated for a skill may provide a brief explanation of the skill aligned to a specific domain/industry in scope along with its applications, main activities or competencies associated with the skill, and tools and technologies used in conjunction with the skill. Such a method of generating the descriptions may aid in standardizing the skill descriptions across different job description attributes and user profile attributes specific to function/domain/industry, while ensuring consistency and thoroughness in the descriptions and improving an overall alignment score between similar skill pairs.

Implementations of the present disclosure are further described for generating the descriptions for skills, however it would be obvious to a person skilled in the art that the descriptions for other attributes in the user profile attributes 454 and the job description attributes 456 may be generated in a similar manner. For generating the descriptions for the skills (e.g., the standardized skills) using the LLM 462, a series of prompts may be generated using the COT techniques. The series of prompts generated using the COT techniques may prompt the LLM 462 to determine core responsibilities and required skills, contextualize the core responsibilities and required skills within the specific domain and generate/curate/craft the descriptions including accurate and short title descriptions. Exemplary prompts generated for the LL M 462 to curate the descriptions may include:
“You are an expert in curating a short description for a given skill based on a given instruction. instruction:
####
Generate a short description for the skill—{skill} within the context of {function} function in healthcare & pharmaceutical domain
####
Ensure to follow the below guidelines while curating the short descriptions
####
1. The description should a give brief explanation of what the skill entails.
2. The description should outline the main activities or competencies associated with the skill. This can include specific tasks, techniques, or methods used when applying the skill.
3. The description can mention relevant tools, software, or technologies if any, that are commonly used in conjunction with the skill.
####

The output should only contain a paragraph about the skill description not more than in three sentences.”

In some other examples, if the user profile attributes 454 and the job description attributes 456 are associated with good quality and include experience level information for all the users/candidates and well-described job description attributes for all open roles in scope, the document processing engine 116 may use one of the fine-tuned LLMs 224 to generate the descriptions corresponding to the user profile attributes 454 and the job description attributes 456.

Referring back to FIG. 4A, once the skills from the user profile attributes 454 and the job description attributes 456 are standardized and the descriptions have been generated for the user profile attributes 454 and the job description attributes 456, at step 412, the method 400 includes determining skills similarities and roles similarities using the descriptions generated for the user profile attributes 454 and the job description attributes 456. Determining the skill similarities may include determining similarities or proximities between pairs of skills (hereinafter referred to as skill pairs) using the descriptions that include descriptions of the skills from the user profile attributes 454 and the job description attributes 456. Each skill pair may include a skill from the user profile attributes 454 and a skill from the job description attributes 456. Therefore, determining the skill similarities may involve assessing how closely the skills from the user profile attributes 454 match with the skills from the job description attributes 456 (e.g., how closely the skills of the users/candidates match with the skills required for a specific job). Determining the role similarities may include determining similarities or proximities between pairs of roles (hereinafter referred to as role pairs) using the descriptions that include descriptions of the roles from the user profile attributes 454 and the job description attributes 456. Each role pair may include a role/role title from the user profile attributes 454 and a role/role title from the job description attributes 456. Determining the skills similarities and the roles similarities may ensure alignment of the skills and the roles between the user profile attributes 454 and the job description attributes 456.

For determining the skills similarities and the roles similarities, the document processing engine 116 may identify and represent semantic relationship between the skill pairs/the role pairs using a skill and role ontology. The skill and role ontology may be a repository of relationships or similarities/proximities between the skills pairs/role pairs represented as numerical scores/ontology scores. An ontology score/proximity score may identify a semantic relationship for the respective skill pair/role pair. The ontology score may be a statistical score within a range of ‘0’ to ‘1’, wherein ‘0’ may represent low similarity/proximity between the respective skill pair/role pair and ‘1’ may represent high similarity/proximity between the respective skill pair/role pair. The skill pairs/competencies with the highest ontology score may be considered as complementary skill pairs (e.g., in terms of functionality that is human resource management against talent acquisition) or supplementary skills (e.g., a skill may replace another skill, for example, “Python” may replace “r programming”). The extracted semantic relationship between the skill pairs/role pairs from the skill and role ontology may aid in matching or repurposing profiles of existing users/employees to vacant/open roles holistically by checking at their expanded skill set with respect to core skill set.

For determining the skill similarities/role similarities using the skill and role ontology, the document processing engine 116 may prepare the skill pairs/role pairs that include combined skills from the user profile attributes 454 and the job description attributes 456 along with the descriptions generated for the skill pairs/role pairs. As the descriptions have been generated using the LLM 462 (described in detail in conjunction with FIG. 4B), the descriptions may include different distinctions of expertise or talent needed for a job or task using the respective skill. Further, the document processing engine 116 may preprocess the descriptions of the skill pairs/role pairs. Preprocessing of the descriptions may include removal of non-ASCII values, special characters, HTML tags, stop words, punctuation and other inappropriate/unnecessary characters from the descriptions.

After preprocessing the descriptions of the skill pairs/role pairs, the document processing engine 116 may convert the descriptions of the skill pairs/role pairs into sentence embeddings using the embedding models 228. The sentence embeddings may include numerical vector representations of entire sentences in the descriptions of the skill pairs/role pairs, capturing semantic meaning in a compact and fixed-dimensional format.

To illustrate in detail, for converting the descriptions of the skill pairs/role pairs into the sentence embeddings, the document processing engine 116 may initialize a tokenizer and an embedding model of the embedding models 228. In an example, the tokenizer and the embedding model may be initialized as:
“Tokenizer=AutoTokenizer.from_pretrained (“meta-llama/Llama-2-13b-chat-hf”)
Embedding M odel=AutoM odel.from_pretrained (“meta-llama/Llama-2-13b-chat-hf “)”
wherein, “meta-llama/Llama-2-13b-chat-hf” may be an example of the embedding model and “meta-llama/Llama-2-13b-chat-hf” may be an example of the tokenizer.

Upon initializing the tokenizer and the embedding model, the document processing engine 116 may use the tokenizer to convert the descriptions of the skill pairs/role pairs into the tokenized inputs. The tokenized inputs may be suitable for the embedding model. The document processing engine 116 may use the embedding model to generate the token embeddings by processing the tokenized inputs. The document processing engine 116 may define a mean pooling function and use the mean pooling function to generate the sentence embeddings. The mean pooling function may identify encoded vectors of individual words in the descriptions, aggregate the individual tokenized embeddings into sentence embeddings, and consider an attention mask to account for padding tokens. The sentence embeddings may include a single vector representation for each sentence in the descriptions of the skill pairs/role pairs.

Once the descriptions of the skill pairs/role pairs are converted into the sentence embeddings, the document processing engine 116 may further convert the sentence embeddings into a data frame for easier manipulation and integration with other data for determining the similarities between the skill pairs/role pairs. The data frame may correspond to a representation of the sentence embeddings in rows and columns. Within the identified data frame, the document processing engine 116 may apply similarity techniques on the sentence embeddings (or word embeddings of the descriptions) to determine the similarities between the skill pairs/role pairs. Non-limiting examples of the similarity techniques may include cosine similarity, Jaccard similarity or any other distance metrics.

An example illustration 400-1 of determining the similarities between the skill pairs/role pairs using the cosine similarity is depicted in FIG. 4C. The cosine similarity may capture the similarities between the skill pairs/role pairs by considering an angle between vectors (′A′ and ‘B’ as depicted in FIG. 4C), which may align more closely with how semantic relationships function. As depicted in FIG. 4C, the document processing engine 116, using the cosine similarity, may compute a cosine of an angle (hereinafter referred to as cosine score) between two vectors in the sentence embeddings. The vectors in the sentence embeddings may identify the skill pairs/role pairs. The cosine score between the two vectors may vary between ‘−1’ and ‘1’, where ‘1’ may indicate an identical orientation, ‘0’ may indicate orthogonality, and ‘−1’ may indicate completely opposite orientation. The document processing engine 116 may approximate the cosine score between the two vectors to ‘0’, upon identifying a negative proximity or the cosine score between the two vectors is ‘−1’, thereby identifying that the skills/roles in a skill pair/role pair corresponding to the two vectors may be semantically dissimilar. An exemplary table illustrating the cosine scores between the two vectors representing the skill pairs is depicted below:

TABLE 2
Cosine scores between the skills in the skill pairs

| Skills from | Skills from User | |
|---|---|---|
| Job Description | profile attributes | Cosine |
| Attributes (Vector A) | (Vector B) | Score |
| Market access | Market access | 1.000 |
| contract operations | contract operations | |
| Market access | Managed care | 0.934 |
| contract operations | contracts | |
| Market access | Contract | 0.926 |
| contract operations | management | |
| Market access | Government contracts | 0.896 |
| contract operations | management | |
| Market access | Managed care | 0.887 |
| contract operations | contracts | |
| Market access | Payer or | 0.882 |
| contract operations | contracting strategy | |
| Market access | Negotiation skills | 0.836 |
| contract operations | | |
| Market access | Influence and | 0.824 |
| contract operations | Leadership | |
| Market access | Account | 0.783 |
| contract operations | management | |

Based on the cosine scores of the skill pairs/role pairs, the document processing engine 116 may determine the skill similarities/role similarities. It should be noted that the cosine scores may be referred to as the ontology scores/proximity scores.

Referring back to FIG. 4A, after determining the skill similarities/role similarities, at step 414, the method 400 includes determining a skill ontology score for each of the skill pairs. The skill ontology score may include an ontology score/proximity score for the respective skill pair. For determining the skill ontology score, the document processing engine 116 may identify the cosine score computed for the respective skill pair and use the cosine score for determining an angle of similarity and orientation associated with the respective skill pair. Based on the determined angle of similarity and orientation, the document processing engine 116 may determine the skill ontology score.

Once the skill ontology score is determined, at step 416A, the method 400 includes determining and updating a skill match score. The skill match score may be determined based on the skill ontology score (determined at step 414). The skill match score may be further updated based on one or more of: a relevancy factor, a proficiency delta value, an alignment value, a minimum proximity threshold value, and a proximity percentage value. The relevancy factor, the proficiency delta value, the alignment value, the minimum proximity threshold value, and the proximity percentage value may be determined by extracting talent features from the user profile attributes 454. The talent features from the user profile attributes 454 may act as additional attributes that may provide deeper insights into the skills and the roles, thereby enabling refined and accurate assessment of the user profile attributes 454 with respect to the job description attributes 456. Refined and accurate assessment of the user profile attributes 454 with respect to the job description attributes 456 may enhance the efficiency and effectiveness of talent acquisition and selection processes.

Non-limiting examples of the talent features may include a role type, a type of each skill (e.g., skill type), a role career level, a proficiency level associated with each of the skills, the similarities between the skill pairs, and/or the like. The proficiency level associated with each of the skills and determining the proficiency level associated with each of the skills are described in detail along with step 408A, therefore repeated description is omitted herein for sake of brevity. The similarities between the skill pairs and determining the similarities between the skill pairs are described in detail along with step 412, therefore repeated description is omitted herein for sake of brevity.

The role type may indicate categories/classifications assigned for the role by processing a title and a description of the role. In an example, the role type may be categorized as: technical”, “functional”, and “creative”. The skill type may indicate categories/classifications assigned for the skills based on names of the skills and the description of the skills. In an example, the skill type may be categorized as technical skills, soft skills, functional/domain skills, and/or the like. The role career level (e.g., a career level of the role) may be determined using the description of the role as well as a context associated with the enterprise including a function as well as an industry. In an example, the role career level may be categorized as entry-level, mid-level, senior-level, and leadership-level. In some examples, the document processing engine 116 may use an LL M-based classification technique to determine or categorize the role type, the skill type, and the role career level.

To illustrate in detail, the document processing engine 116 may select an LLM from open-source LLMs for determining or categorizing the role type, the skill type, and the role career level. In an example, the selected LLM may include a mixture-of-experts (MoE) architecture with a total of 132 billion parameters and provide a robust and advanced solutions for natural language processing tasks. The document processing engine 116 may train the selected LLM utilizing open source libraries, for example, MegaBlocks, LLM Foundry, Composer, and Streaming. Such a training of the LLM may improve efficiency and accuracy of categorizing the talent features such as the role type, the role career level, and the skill type.

Once the selected LLM is trained, the document processing engine 116 may prepare a multiclass classification context for each of the role type, the skill type, and the role career level. An exemplary multiclass classification context may include:
“skill_type_context_standard=”””

### Skill Type Context:

### 1. Soft Skills

a. Interpersonal Communication: Soft skills often involve the ability to communicate effectively with others, including active listening, empathy, and the capacity to convey ideas clearly and diplomatically.
b. Adaptability: Soft skills frequently encompass the capability to adapt to changing circumstances and environments. This may involve being open to new ideas, flexibility in approach, and resilience in the face of challenges.
   c. Collaboration

### 2. Technical Skills

a. Specialized Knowledge: Technical skills involve specialized knowledge and expertise in specific tools, technologies, or methodologies within a particular domain. This knowledge is typically acquired through education, training, and hands-on experience.
b. Precision and Accuracy: Technical skills demand a high level of precision and accuracy in execution. Whether it's coding, engineering design, or data analysis, precision ensures that tasks are completed correctly and efficiently, minimizing errors and inconsistencies.
   c. Technology Focused: Technical skills are.

### 3. Functional Skills

a. Business/Operations Focused: Functional skills are oriented towards supporting business or operational objectives within an organization. They are often aimed at improving efficiency, productivity, and effectiveness in various business functions.
b. Strategic Impact: Functional skills have a strategic impact on organizational goals and objectives. They contribute to the development and execution of strategic plans, influencing decision-making processes and long-term outcomes.
   c. General—Applicability:

After preparing the multiclass classification context for each of the role type, the skill type, and the role career level, the document processing engine 116 may create prompts corresponding to each multiclass classification context. An exemplary prompt may include:
“prompt=f”””
##Classes: {classes_skill_type}
##Instruction: You are a helpful AI assistant who excels at classifying an input entity into predefined classes. Y our primary goal is to use an input entity along with a context and classify it into appropriate class. An input could potentially align to multiple values, but your job is to identify which of the classes that the input aligns to best.
##Context: {context} ##Inputs:
Name: {name}
Description: {description} ##Output Format:
Result Only ##Important:
Result Key must match one of the Classes: {classes_skill_type}

In the above-described exemplary prompt,
classes_skill_type= “technical skills, soft skills, functional/domain-specific skills”
context=skill_type_context_standard (defined above)
name=name of the skill in scope
description=skill description

The document processing engine 116 may provide the prompts to the selected and trained LLM, which may determine or categorize the role type, the skill type, and the role career level.

Once the talent features (the role type, the skill type, the role career level, the proficiency levels, the similarities between the skill pairs, and/or the like) are extracted from the user profile attributes 454, the document processing engine 116 may use one or more of the talent features to determine the relevance factor, the proficiency delta value, the alignment value, the minimum proximity threshold value, and the proximity percentage value.

The relevance factor (also referred to as skill relevance factor) may determine importance of different skill types for a specific target job role specified in the job description attributes 456. In some examples, the document processing engine 116 may use a relevancy rule that defines a skill relevance distribution to determine the relevance factor based on a relative importance of each skill to the specific target job role. The relevance importance of each skill to the specific target job role may be identified by factoring in the skill type, the role type, and the role career level. An exemplary relevance rule may include:

{″role_technical″: {″entry-level″: {″skill_technical″: .6 , ″skill_domain/functional″: . 3,
″skill_leadership″: .1},
″mid-level″: {″skill_technical″: .5, ″skill_domain/functional″: .3, ″skill_leadership″: .2},
″senior-level″:{″skill_technical″: .4, ″skill_domain/functional″: .3, ″skill_leadership″: .3},
″leadership-level″:{″skill_technical″: .4,″skill_domain/functional″: . 3, ″skill_leadership″: . 3}},
″role_functional″: {″entry-level″: {″skill_technical″: .3 , ″skill_domain/functional″: .6,
″skill_leadership″: .1},
″mid-level″: {″skill_technical″: .3, ″skill_domain/functional″: .5, ″skill_leadership″: .2},
″senior-level″:{″skill_technical″: .2, ″skill_domain/functional″: .5, ″skill_leadership″: .3},
″leadership-level″:{″skill_technical″:″.2″ , ″skill_domain/functional″:″.5″,
″skill_leadership″:″.3″}},
″role_creative″: {″entry-level″: {″skill_technical″:″.1″ , ″skill_domain″:″.3″.
″skill_creative,″:″.6″},
″mid-level″: {″skill_technical″:″.2″ , ″skill_domain″:″.3″, ″skill_creative,″:″.5″},
″senior-level″:{″skill_technical″:″.3″ , ″skill_domain″:″.3″, ″skill_creative,″:″.4″},
″leadership-level″:{″skill_technical″:″.3″ , ″skill_domain″:″.3″, ″skill_creative,″:″.4″}}}

It should be noted that weights included in the above-described exemplary relevance rule may include some sample weights such as ‘0.1’-‘0.6’. However, it should be obvious to a person skilled in the art that the weights may vary in the range of ‘0’ to ‘1’. For example, for a role type like “Senior Software Engineer (Technical, Mid-Level Role), technical skills remain important, but there is an increased need for domain/functional expertise. The role type may involve more complex problem-solving and system design tasks, and the role type may often be expected to take on some leadership roles such as mentoring junior team members and coordinating small projects. For such a role type, an exemplary relevance rule defining skill relevance distribution may include:

### “Technical Skills: 50%

Example Skills: Advanced Programming, System Design, Code Optimization Domain/Functional Skills: 30%
Example Skills: In-depth Knowledge of A gile Methodologies, DevOps Practices Leadership Skills: 20%
Example Skills: Project Coordination, Mentoring Junior Engineers, Project Management”

The proficiency delta value (also referred to as delta in proficiencies) may determine how a competence of the user/candidate in a specific skill deviates from the target job role. By way of non-limiting example, the proficiency delta value may reflect a difference between the proficiency levels required for the skills corresponding to the target job role and the proficiency levels possessed by the user/candidate with respect to the required skills. The proficiency delta value may be used to adjust minimum and high proximity scores (e.g., collectively referred to as the minimum proximity threshold value and/or the proximity percentage value) and provide penalization percentages (may range from 0% to 10%) to penalize the minimum and high proximity scores based on how much the proficiency levels of the user/candidate deviate from the required proficiency levels. In an example, the proficiency delta value may be computed as:

“if ([′skill_proficiency_job′] - [′skill_proficiency_candidate′] >= 2):
return 0.950
elseif ([′skill_proficiency_job′] - [′skill_proficiency_candidate′] == 1):
return 0.975
else:
return 1”

In some examples, the penalization percentages/scores may be derived using sample penalization rules. An exemplary sample penalization rule may include: Proficiency delta value=2: If the target job role requires a proficiency level that is two levels or higher than the proficiency level of the user/candidate, a penalty factor of 0.950 is applied to reduce the minimum and high proximity scores by 5%.

Proficiency delta value=1: If the target job role requires a proficiency level that is one level higher than the proficiency level of the user/candidate, a penalty factor of 0.975 is applied to reduce the minimum and high proximity scores by 2.5%.

Proficiency delta value≤0: If the proficiency level of the user/candidate meets or exceeds the proficiency level of the target job role, no penalty is applied, and an associated factor remains 1.000.

The alignment value (also referred to as skill type alignment) may determine whether the different skill types being aligned with each other or not. The document processing engine 116 may determine the semantic pairs (e.g., the skill pairs including the skills that are matched semantically), each with the ontology score, while performing step 410, however, the different skill types being matched may not align with each other that may further result in consideration of incorrect skills for the target job role. Therefore, to avoid any misalignment between the different skill types, the alignment may be used. The alignment value may aid in ensuring that the different skill types have been evaluated appropriately and have not been falsely equated as unrelated skill types. In an example, the document processing engine 116 may use a sample alignment rule for determining the alignment value. An exemplary alignment rule may indicate that:

“Soft skills from the job description attributes 456 have to be matched only by soft skills from the user profile attributes 454.

Functional/technical skills from the job description attributes 456 have to be matched only by functional/technical skills from the user profile attributes 454.

If the skill types match per the above-described criteria, the ontology/proximity score associated with the respective semantic pair remains unchanged.

If the skill types do not match per the above-described criteria, a penalty is applied to reduce the ontology/proximity score associated with the respective semantic pair by 50%.”

The document processing engine 116 may determine the semantic pairs with the ontology/proximity scores that are less than the minimum proximity threshold value and disregard the semantic pairs. In an example, the minimum proximity threshold value may include 50%. For example, the semantic pairs associated with the ontology/proximity scores of equal to or greater than 50% are considered for further evaluation, which may ensure that the semantic pairs that weak proximities/similarities (e.g., with the ontology/proximity scores below 50%) are not considered for overall processing of the user profile attributes 454 with respect to the job description attributes 456.

In an example, the proximity percentage value (also referred to as high skill proximity) may include 75%. The document processing engine 116 may identify the semantic pairs with the ontology/proximity scores greater than the proximity percentage value as high skill proximities or rewarding pairs and use the respective ontology/proximity scores to update the skill match score.

The document processing engine 116 may use sample high proximity rules based on the proximity percentage value to update the match score. An exemplary high proximity rule may include: “If a percentage of the high skill proximities is 75% or more, the skill match score is increased by 5%.

If the percentage of the high skill proximities is between 50% and 75%, the skill match score remains unchanged.

If the percentage of the high proximities is between 35% and 50%, the skill match score is reduced by 10%.

If the percentage of the high proximities is below 35%, the skill match score is reduced by 20%.”

Once the semantic pairs associated with the ontology/proximity scores less than the minimum proximity threshold value are disregarded and the semantic pairs associated with the high skill proximities/proximity percentage value are considered, the document processing engine 116 may update the skill match score based on the relevance factor, the proficiency delta value and the alignment value. In an example, the skill match score may be updated as:

$$Skill match score = \frac{\begin{matrix}\sum ( high skill proximities \times relevance factor \times \\ proficiency delta value )\end{matrix}}{\sum ( relevance factor )}$$

wherein the high skill proximities may indicate a measure of high semantic similarity for each skill in the job description attributes 456 from the skills in the user profile attributes 454, the relevance factor may indicate importance of each skill in the context of each target job role, and the proficiency delta value may indicate an adjustment factor based on the differences in the proficiency levels required for the target job role and the proficiency levels possessed by the user/candidate.

In parallel to the determination of the skill match score, at step 416B, the method 400 includes determining and updating a role match score. It should be noted that the skill match score and the role match score form the primary match score.

For determining the skill match score, the document processing engine 116 may identify the ontology/proximity scores assigned with the role pairs (e.g., each role pair may include a role from the user profile attributes 454 and the job description attributes 456) and compute a weighted score based on the identified ontology/proximity scores. The weighted score may indicate the role match score. In some examples, the role match score may be further updated based on role related talent features such as a role type mismatch, a role career level mismatch, a delta value related to education, a delta value related to salary, a delta value related to years of experience, and/or the like. The role related talent features may be derived by comparing role related features associated with the user profile attributes 454 with respect to role related features associated with the job description attributes 456. The role related features may include, but are not limited to, a role type, a role career level, education, a salary, years of experience, and/or the like.

Once the skill match score and the role match score (e.g., the primary match score) are determined and updated, at step 418, the method 400 includes determining and updating the net match score for each user profile attribute with respect to one of the target job roles. The net match score may provide a comprehensive assessment of suitability of the user/candidate to the target job role in the job description attributes 456. The net match score may be computed by considering the determined/updated skill match score and the determined/updated role match score using a weighted average approach. In an example, the net match score may be computed as:

Net match score=(skill match score×0.7)+(role match score×0.3)
wherein, ‘0.7’ and ‘0.3’ may be sample or exemplary weights assigned for the skill match score and the role match score, however as would be understood that the weights may range from ‘0’ to ‘1’.

Once the net match score is determined, the net match score may be updated based on a role type mismatch factor and a role career level mismatch factor. It should be noted that the role type mismatch factor and the role career level mismatch factor may be collectively referred to as the mismatch between attribute level of the user profile attributes 454 and the job description attributes 456.

The different role types in the job description attributes 456 may require distinct skills and expertise. For example, a role type like a technical role may demand strong technical skills including usage of tools and programming languages, while a functional role may provide attention to enterprise and operational skills. An obvious mismatch between the role type of the target job role and the role type associated with the user/candidate in the user profile attributes 454 may impact suitability of the user/candidate for the target job role. Therefore, the role type mismatch factor may be used to update/penalize the net match score by identifying the mismatch between the role types in the user profile attributes 454 and in the job description attributes 456. Updating/penalizing the net match score using the role type mismatch factor may ensure that the users/candidates with the most relevant role in the user profile attributes 454 are prioritized for the target job role in the job description attributes 456. The role type mismatch factor may be determined and used to update/penalize the net match score based on a set of role type sample conditions. An exemplary set of sample role type conditions may include:

“If the role type is “technical” and the candidate's current role type is “functional” or “creative”, the net match score is reduced by 20%.

If the role type is “functional” and the candidate's current role type is “technical” or “creative”, the net match score is also reduced by 20%.

If the role type is “creative” and the candidate's current role type is “functional” or “technical”, the net match score is also reduced by 20%.

If the role types match or do not fall into these specific mismatches, the match score remains unchanged.”

The above-described percentages for updating/penalizing the net match score are sample percentages, however as would be understood, the percentages may be in the range of 0 to 25%. Updating/penalizing the net match score based on the role type mismatch factor may aid in reducing likelihood of selecting the users/candidates who have artificially inflated their demographic documents/resumes to include all the skills required for the target job role. For example, a functional candidate claiming to have extensive technical skills (or vice versa) may be flagged by updating/penalizing the net match score based on the role type mismatch. Therefore, even if such a candidate lists all required skills in a resume, associated latest experience in a different role type (e.g., functional vs. technical) may reduce the net match score, thereby prioritizing the users/candidates whose resumes genuinely reflect their expertise.

Updating/determining the net match score based on the role career level mismatch factor may ensure that the users/candidates are appropriately matched to the target job roles that align with their level of experience and career progression. Therefore, the usage of the role career level mismatch factor may prevent selection of the users/candidates who are either underqualified or overqualified for the target job role, while promoting improved job-match and reducing a likelihood of turnover or dissatisfaction. The role career level mismatch factor may be determined and used to update/penalize the net match score based on a set of career level sample conditions. An exemplary set of sample career level conditions may include: “Severe Mismatch (Two or More Levels):

If the target job's career level is two or more levels above or below the candidate's career level, the net match score is reduced by 50%. Such a penalization reflects the significant gap in required experience and suitability.

### Moderate Mismatch (One Level Below):

If the candidate is one level below the target job's career level, the net match score is reduced by 10%. Such a minor penalty reflects the potential for the candidate to grow into the role.

Exact or Near Match (Same Level or One Level A bove):

If the candidate's career level matches the target job's career level or is one level above, the net match score remains unchanged, which may further indicate a good alignment in terms of experience and qualifications.”

The above-described percentages for updating/penalizing the net match score are sample percentages, however as would be understood, the percentages may be in the range of 0 to 60%.

While implementations of the present disclosure are described by considering the role type mismatch factor and the role career level mismatch factor for updating/penalizing the net match score, it is contemplated that the net match score may be updated/penalized by considering other similar factors such as an education mismatch factor, a salary mismatch factor, a years of experience mismatch factor, and/or the like or any other factors that may be derived from available data in the user profile attributes 454 and the job description attributes 456 based on a specific use case in scope. Such a updating/penalizing the net match score may ensure a more precise alignment between the user profile attributes 454 and the job description attributes 456.

Based on the determined and updated net match score, at step 420, the method 400 includes determining mapped roles. Each of the mapped roles may include the role/skills from the user profile attributes 454 matched/mapped with the target job role in the job description attributes 456.

At step 422, the method 400 includes generating upskilling recommendations. The upskilling recommendations may recommend transitions to be applied to the mapped roles based on analysis of skill gaps. Step 422 of generating the upskilling recommendations is described in detail in conjunction with FIG. 4D.

As depicted in FIG. 4D, at step 422A, the method 400 includes performing gap analysis. In an example, the gap analysis may include identifying and performing assessment of skill gaps using the skill ontology score determined for each skill pair at step 414. The skill pair may include a skill from the user profile attributes 454 and a skill from the job description attributes 456. For identifying and performing assessment of skill gaps, the document processing engine 116 may identify the skill pairs having the skill ontology scores below the ontology score threshold value (e.g., first predefined threshold value). Such skill pairs may be considered as low-grade skills (e.g., low-grade attributes). Similarly, the document processing engine 116 may identify the skill pairs having the skill ontology scores above the ontology score threshold value. Such skill pairs may be considered as baseline skill pairs (e.g., baseline attributes). In an example, the ontology score threshold value may be defined as 65% by performing empirical testing on the skills present in the user profile attributes 454 and the job description attributes 456. Further, the document processing engine 116 may identify the skill gaps that identify gap levels between the baseline skill pairs and the low-grade skill pairs. A gap level may indicate a gap in the similarity level between the skills in the skill pairs.

At step 422B, the method 400 includes computing a role-to-skill relevance index value (e.g., relevance index value) that determines how much each skill in the job description attributes 456 is relevant to the target job role in the job description attributes 456. The role-to-skill relevance index value may be computed by factoring in a correlation between parameters such as a total demand factor (e.g., a total demand of a specific skill in a job market), a forecasted market trend of the skill per third party data and insight providers as well as the role types and the skill types extracted from the user profile attributes 454 and the job description attributes 456. In an example, the role-to-skill relevance index value may be computed as:

Y=(ω₁F₁+ω₂F2+ω₃F3)
wherein, (i) ‘Y’ represents the relevance index value.
(ii) ‘F1’ represents the total demand factor. The total demand factor may be a derivative of a total demand for the skill for a specific role across multiple enterprises in a particular industry/domain for a specific time period. The total demand may be aggregated using job posting data available on third party databases, open source databases, and through external sources/insight providers.
(iii) ‘F2’ represents the forecasted market trend/industry view of the specific skill per specific industry per proprietary forecasting module.
(vi) ‘F3’ represents a prioritization factor that has been derived based on the skill type (e.g., functional, technical, leadership, and/or the like). The prioritization factor is analogous to the skill relevance factor determined for updating/penalizing the net match score at step 418.
(v) ‘ω₁’, ‘ω₂’, and ‘ω₃’ may indicate weights.

Exemplary parameters and weight ranges used to compute the role-to-skill index are illustrated in the below table:

TABLE 3
Exemplary parameters and ranges of weights
for computing relevance index

| Factor | Weight | Weight Range |
|---|---|---|
| Total Demand | ω1 | 0.10-0.30 |
| Forecasted skill trend | ω2 | 0.25-0.40 |
| Prioritization Factor/Skill | ω3 | 0.25-0.40 |
| Relevance Factor | | |

Upon computing the role-to-skill relevance index value, at step 422C, the method 400 includes determining the optimal learning pathway (also referred to as upskilling pathway), based on the skill gaps and the role-to-skill relevance index value. The optimal learning pathway may be determined by integrating the role-to-skill relevance index value with the skill ontology scores determined at step 414 for the skills in the skill pairs. The optimal learning pathway may outline an order of upskilling/reskilling for each current state of the user profile attributes 454 to target state transition. In an example, the optimal learning pathway may be determined based on a weighted average of the role-to-skill relevance index value and the skill ontology scores, which is represented as:

I=∝₁S₁+∝₂S₂
wherein, (0<∝₁, ∝₂<1) and (∝₁+∝₂=1)

The optimal learning pathway data may include (i) skills to be upskilled and sorted in a sequential order (e.g., descending order) of the integrated role-to-skill relevance index value, (ii) similar skills (e.g., skill pairs with the ontology scores greater than the ontology score threshold value) sorted in the sequential order (e.g., descending order) of the integrated role-to-skill relevance index value. The sequence of skills to be upskilled may provide guidance for the users/candidates to follow during upskilling/learning process to perform transition to the target job role. For example, during the upskilling/learning process, the users/candidates may start enrolling for beginner level courses for upskilling. The users/candidates may also consider sequence of similar skills in the optimum learning pathway to acquire upskilled to a more advanced level of proficiency in case their existing proficiency level is below the target role expectations.

The optimal learning pathway in the present disclosure may provide a detailed and structured learning roadmap for the users/candidates for upskilling their skills, thereby mitigating close the identified skills gaps. The optimal learning pathway may be presented to the users/candidates via interfaces of respective user devices (not shown), which may allow the users/candidates to track progress of the users/candidates and pursue targeted upskilling activities to meet the expectations of the target job role.

At step 422D, the method 400 includes determining the transitions to be applied for each of the mapped roles, based on the determined optimal learning pathway. The determined transition may be provided as the recommendations, which may ensure a more dynamic and adaptable workforce, and capable of satisfying evolving demands of the job market.

In some examples, the recommendations may include learning programs and course recommendations derived based on the determined transitions. The learning programs and course recommendations may provide a structured learning sequence tailored to satisfy target role's skill requirements. The learning programs and course recommendations may aid in identifying the appropriate courses and training levels needed, aligning them with the desired expertise level for each skill to fulfil the roles and responsibilities. In some other examples, the recommendations may be used for workforce learning, internal restructuring of the enterprise, new hires/recruitment, deriving performance improvement programs, and/or the like.

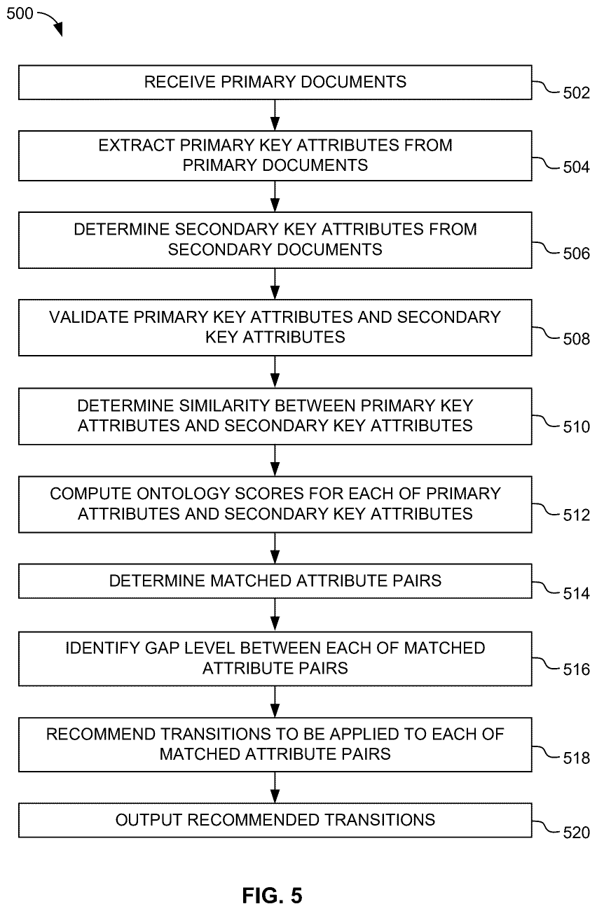

FIG. 5 illustrates a flow diagram that presents a method 500 for extracting and matching key attributes from documents, in accordance with implementations of the present disclosure. The method 500 may be executed by the document processing system 102.

At step 502, the method 500 includes receiving, by the processor 112, primary documents from the data sources 104. The primary documents include synthetic datasets and raw datasets. The primary documents include at least one of user demographic documents, user medical documents, user legal documents, and user compliance documents.

At step 504, the method 500 includes extracting, by the processor 112, primary key attributes from the primary documents using fine-tuned LLMs (e.g., the fine-tuned LLMs 224).

The primary key attributes include one of user demographic data, user qualification data, user medical data, user compliance data, and user proficiency level data.

In some implementations, to extract the primary key attributes from the primary documents the method 500 further includes: (1) generating, by the processor 112, prompts for each of the primary documents. The prompts include at least user defined instructions for extracting the primary key attributes, and (2) extracting, by the processor 112, the primary key attributes, using the fine-tuned LLMs 224, based on the generated prompts.

In some examples, upon extracting the primary key attributes, the method 500 further includes determining proficiency levels corresponding to the primary key attributes, using the fine-tuned LLMs 224 and generating user proficiency level data, based on the determined proficiency levels. The user proficiency level data correspond to a dataset that includes the proficiency level of the primary key attributes. The proficiency level corresponds to a level of expertise associated with the user. For determining the proficiency levels, the method 500 includes (i) identifying the key indicators associated with the primary key attributes, (ii) generating a graphical representation of the primary key attributes, based on the identified key indicators, (iii) identifying the similarity between the primary key attributes, based on the generated graphical representation, (iv) creating a clustered data by clustering the similar primary key attributes into cluster groups, (v) creating an aggregated data by aggregating a period of usage value of each of the primary key attributes in the created clustered data, and (vi) determining the proficiency level of each of the primary key attributes, based on the aggregated data. Further, to identify the key indicators associated with the primary key attributes, the method 500 includes (i) identifying predefined keywords in the primary key attributes, (ii) identifying the period of usage value of each of the primary key attributes, based on the identified predefined keywords, and (iii) identifying a frequency of occurrence of each of the primary key attributes, based on the identified period usage value.

At step 506, the method 500 includes determining, by the processor 112, secondary key attributes from secondary documents received from the enterprise data sources 106, using the fine-tuned LLMs 224. The secondary documents include one of target demographic documents, target medical documents, target legal documents, and target compliance documents. The secondary key attributes include one of target demographic data, target qualification data, target medical data, and target compliance data, and target proficiency level data.

In some examples, upon extracting the secondary key attributes, the method 500 further includes identifying primary key words in the secondary documents, identifying proficiency indicators in the secondary documents, determining a proficiency level of the secondary key attributes based on the primary key words and the proficiency indicators, and generating the target proficiency level data, based on the target proficiency level. The primary key words correspond to the secondary key attributes including a highest priority level. The proficiency indicators correspond to secondary key words indicating the proficiency level of the secondary key attributes. The target proficiency level data correspond to a dataset including the proficiency level of the secondary key attributes.

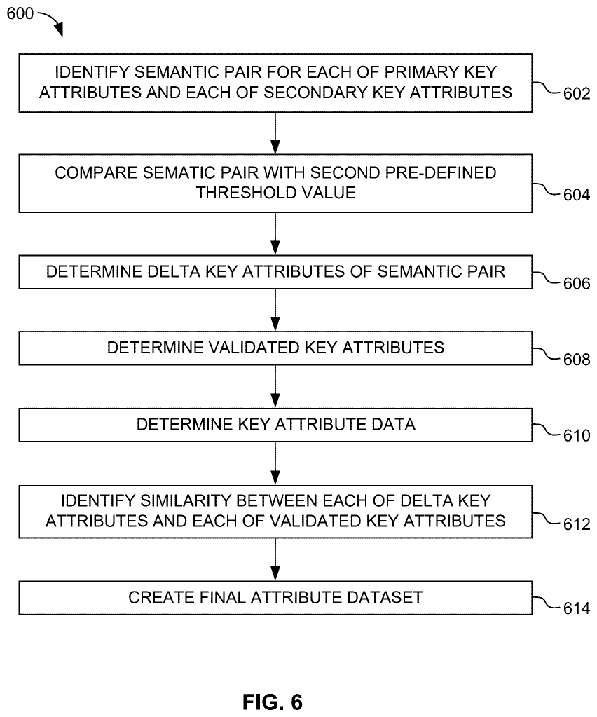

At step 508, the method 500 includes validating, by the processor 112, the primary key attributes, and the secondary key attributes, using the fine-tuned LLMs 224. Validating the primary key attributes and the secondary key attributes are described in detail in conjunction with FIG. 6.

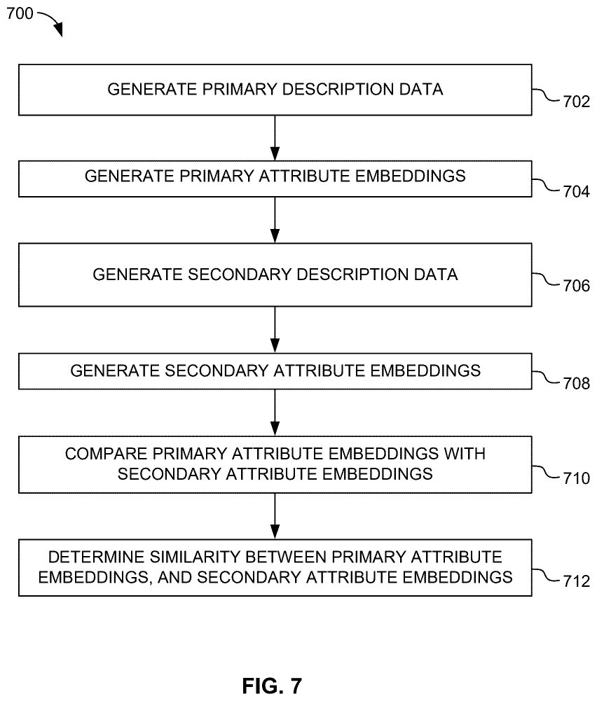

At step 510, the method 500 includes determining, by the processor 112, a similarity between the primary key attributes, and the secondary key attributes based on results of validation. The similarity may be determined by applying the semantic similarity model 226 onto the primary key attributes, and the secondary key attributes. The semantic similarity model 226 includes a cosine similarity model. Determining the similarity between the primary key attributes and the secondary key attributes are described in detail in conjunction with FIG. 7.

At step 512, the method 500 includes computing, by the processor 112, ontology scores for each of the primary key attributes and the secondary key attributes, based on the similarity. The ontology scores correspond to a similarity level between the primary key attributes, and the secondary key attributes.

In some examples, for determining the ontology scores, the method 500 includes (i) determining an angle of similarity between primary attribute embeddings associated with the primary key attributes and secondary attribute embeddings associated with secondary key attributes, (ii) determining an orientation of the primary attribute embeddings relative to the secondary attribute embeddings, based on the angle of similarity, and (iii) computing the ontology scores for each of the primary key attributes and the secondary key attributes, based on the orientation. Computing the ontology scores is explained in detail in conjunction with the score computation module 210 in FIG. 2, therefore repeated description is omitted for sake of brevity.

At step 514, the method 500 includes determining, by the processor 112, matched attribute pairs, by comparing the computed ontology scores with a first predefined threshold value. The fine-tuned LLMs 224 are updated by continuously training the fine-tuned LLMs 224 based on results of determination of the matched attribute pairs.

In some examples, for determining the matched attribute pairs, the method 500 includes (i) determining a primary match score, based on a weighted average of the ontology scores, (ii) updating, the primary match score, based on at least one of a relevancy factor, a proficiency delta value, an alignment value, a minimum proximity threshold value, and a proximity percentage value, (iii) generating a net match score, based on the updated primary match score, (vi) identifying a mismatch between attribute level of the primary key attributes, and the secondary key attributes, and (v) updating the net match score, based on the mismatch identified between the attribute level of the primary key attributes, and the secondary key attributes. The net match score corresponds to an updated primary match score controlled based on one of the relevancy factor, the proficiency delta value, the alignment value, the minimum proximity threshold value, and the proximity percentage value. Determining and updating the net match score are explained in detail in conjunction with the pair determination module 212 in FIG. 2 and in FIG. 4, therefore repeated description is omitted for sake of brevity.

At step 516, the method 500 includes identifying, by the processor 112, a gap level between each of the matched attribute pairs using the fine-tuned LLMs 224.

In some examples, for identifying the gap level, the method 500 includes (i) determining baseline attributes, upon determining that the computed ontology scores exceeding the first predefined threshold value, (ii) determining low-grade attributes, upon identifying the computed ontology scores failing to meet the first predefined threshold value, (iii) comparing the baseline attributes with the low-grade attributes, and (vi) identifying the gap level between the baseline attributes, and the low-grade attributes, based on the comparison. The gap level corresponds to a gap in the similarity level between the determined matched attribute pairs. Identifying the gap level is explained in detail in conjunction with the gap level identification module 214 in FIG. 2 and in FIG. 4A, therefore repeated description is omitted for sake of brevity.

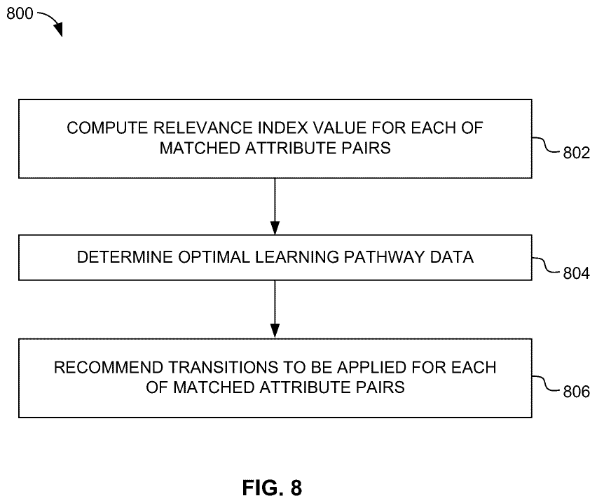

At step 518, the method 500 includes recommending, by the processor 112, transitions to be applied to each of the matched attribute pairs, based on the gap level. The transitions include performing modifications to the matched attribute pairs, to match with the first predefined threshold value. Recommending the transitions is described in detail in conjunction with FIG. 8.

At step 520, the method 500 includes outputting, by the processor 112, the recommended transitions on an interface of the client device 108 and/or on an interface of the user device.

FIG. 6 illustrates a flow diagram that presents a method 600 for validating the primary key attributes, and the secondary key attributes, in accordance with implementations of the present disclosure. The method 600 may be executed by the processor 112 using the validation module 206 as described in relation to FIG. 2.

At step 602, the method 600 includes identifying, by the processor 112, a semantic pair for each of the extracted primary key attributes, and each of the extracted secondary key attributes. At step 604, the method 600 includes comparing, by the processor 112, the identified semantic pair with a second predefined threshold value. At step 606, the method 600 includes determining, by the processor 112, delta key attributes of the semantic pair, based on the comparison. The delta key attributes correspond to the semantic pair failing to exceed the second predefined threshold value. At step 608, the method 600 includes determining, by the processor 112, a validated key attributes, based on the comparison. The validated key attributes correspond to the semantic pair exceeding the second predefined threshold value. At step 610, the method 600 includes determining, by the processor 112, key attribute data, based on the determined delta key attributes, and the determined validated key attributes. The key attribute data correspond to a combination of the determined delta key attributes, and the determined validated key attributes. At step 612, the method 600 includes identifying, by the processor 112, the similarity between each of the delta key attributes, and each of the validated key attributes, within the key attribute data. At step 614, the method 600 includes creating, by the processor 112, a final attribute dataset by filtering similar key attributes from the key attribute data, based on the identified similarity.

FIG. 7 illustrates a flow diagram that presents a method 700 for determining similarity between the primary key attributes, and the secondary key attributes, in accordance with implementations of the present disclosure. The method 700 may be executed by the processor 112 using the similarity determination module 208 as described in relation to FIG. 2.

At step 702, the method 700 includes generating, by the processor 112, primary description data for the primary key attributes using the Gen AI models 223. The primary description data correspond to a detailed textual description of each of the primary key attributes. At step 704, the method 700 includes generating, by the processor 112, primary attribute embeddings by converting the primary description data into a vector embedded representation, using the embedding models 228. At step 706, the method 700 includes generating, by the processor 112, secondary description data for the secondary key attributes using the Generative Artificial Intelligence (AI)-based model. The secondary description data correspond to a detailed textual description of each of the secondary key attributes.

At step 708, the method 700 includes generating, by the processor 112, secondary attribute embeddings by converting the secondary description data into the vector embedded representation, using the embedding models 228. At step 710, the method 700 includes comparing the primary attribute embeddings with the secondary attribute embeddings. For comparison various sub-steps may be performed which are given below.

The sub-steps include pre-processing, by the processor 112, the primary description data, and the secondary description data by filtering external attributes from the primary description data, and the secondary description data. The external attributes include one of non-American Standard Code for Information Interchange (ASCII) values, special characters, Hyper-Text Markup Language (HTML) tags, stop words, punctuation, and unwanted characters. The sub-steps include converting, by the processor 112, the pre-processed primary description data, and the secondary description data into tokenized inputs relevant to the embedding models 228. The sub-steps include generating, by the processor 112, token embeddings, by inputting the tokenized inputs into the embedding models 228. The sub-steps include computing, by the processor 112, sentence embeddings, based on the token embeddings. The sub-steps include converting, by the processor 112, the sentence embeddings into a data frame. The data frame includes the primary attribute embeddings and the secondary attribute embeddings in form of rows and columns. The sub-steps include comparing, by the processor 112, the primary attribute embeddings with the secondary attribute embeddings, based on the created data frame.

At step 712, the method 700 includes determining, by the processor 112, the similarity between the primary attribute embeddings, and the secondary attribute embeddings, by using the semantic similarity model 226 on the primary attribute embeddings, and the secondary attribute embeddings, based on the comparison.

FIG. 8 illustrates a flow diagram that presents a method 800 for recommending the transitions to be applied for the matched attribute pairs, in accordance with implementations of the present disclosure. The method 800 may be executed by the processor 112 using the recommendation module 216 as described in relation to FIG. 2.

At step 802, the method 800 includes computing, by the processor 112, a relevance index value for the each of the matched attribute pairs, based on at least one of a demand factor, a market trend factor, and a prioritization factor. The relevance index value corresponds to a relevancy level of the secondary key attributes with respect to the secondary documents. At step 804, the method 800 includes determining, by the processor 112, an optimal learning pathway data based on a weighted average of the computed relevance index value, and each of the computed ontology scores. The optimal learning pathway data includes at least one of the matched attribute pairs to be updated, sorted in a descending order of the computed relevance index value. The optimal learning pathway data includes at least one of the similar matched attribute pairs sorted in the descending order of the computed relevance index value. At step 806, the method 800 includes recommending, by the processor 112, the transitions to be applied for each of the matched attribute pairs, based on the determined optimal learning pathway data.

Implementations of the present disclosure provide technical solutions to multiple technical problems that arise in document processing. Implementations of the present disclosure may enable processing of the documents with the following advantages:

Reduction in Storage Requirements and Efficient Data Management: Implementations of the present disclosure enable extraction of text data by preprocessing raw-text data of documents (including primary and secondary documents). The text data may be processed to generate final text data and the final text data may be stored in a database instead of storing the entire documents in the database. Therefore, a temporary data storage strategy may be employed to store the final text data that is necessary for further processing while ensuring the final text data may remain lean, efficient, and scalable and optimizing usage of storage resources. Further, implementations of the present disclosure may maximize efficiency of the storage resources by storing the final text data only for as long as the final text data is required for processing, which may reduce usage of the storage resources and operational overhead, while maintaining a high degree of efficiency in managing large volumes of data. Once tasks related to the final text data is performed, intermediate data is purged by preventing unnecessary storage consumption.

Enhanced Data Security: Implementations of the present disclosure further enable extraction of the text data/final text data from the documents by removing sensitive data (e.g., PII) and biased data from the raw text data. Removal of the sensitive data and the biased data and storing of the text data/final data in the database instead of the entire documents may reduce a risk of compromising the sensitive data while mitigating exposure time for the sensitive data by reducing a window of vulnerability. Therefore, implementations of the present disclosure may offer improved data protection, by safeguarding the text data of the documents against potential data leakage or unauthorized access.

Efficient and Scalable Workflow for Instantaneous Data Processing: Implementations of the present disclosure provide instantaneous data processing, ensuring that data ingestion, processing, and match result generation occur in real-time with minimal data storage. The instantaneous data processing leads to reduced data latency and faster processing, benefiting the enterprises that require real-time processing of the documents. Additionally, by leveraging distributed computing frameworks, implementations of the present disclosure enable executing of tasks (e.g., tasks related to processing of the documents) in parallel across multiple compute nodes, dramatically reducing processing time and avoiding the bottlenecks of single-node processing. The distributed computing frameworks ensure that large volumes of documents may be handled efficiently, while seamlessly satisfying demands of high-throughput environments.

Improved Processing Speed and Reduced Latency: By utilizing the distributed computing frameworks and user-defined functions (UDFs), implementations of the present disclosure may achieve significant reductions in latency associated with processing of the documents. The use of Resilient Distributed Datasets (RDDs) (e.g., large set of primary and secondary documents (e.g., resumes and JDs)) allows for parallel execution of tasks, distributing computations across a cluster of nodes. The parallelization minimizes delays typically associated with single-node processing and ensures faster execution of tasks such as skill classification and role matching. For example, a result of parallelization is a 10× reduction in latency, while enabling real-time processing and rapid talent matching even for complex data sets. The optimized processing time enhances overall user experience and provides immediate insights for decision-making.

Advanced Matching of Key Attributes and Attributes Augmentation: Implementations of the present disclosure enable efficient and accurate matching of key attributes (e.g., primary and secondary key attributes) extracted from the documents (e.g., primary and secondary documents) using one or more models (e.g., semantic similarity and embedding models). For example, if the documents include candidate profiles/demographic documents and job descriptions, an embedding technique allows for the analysis of similarity between the candidate profiles and the job descriptions, ensuring that matches are contextually relevant and highly precise. Additionally, LLMs may be used to generate synthetic descriptions for the key attributes extracted from the documents, upon creating consistent key attributes and standardizing the key attributes across the various domains/industries. The creation of consistent and standardized attributes may not only improves a match score for each of the key attributes but also ensures that the key attributes are interpreted in a standardized manner across various domains and industries, enhancing overall alignment between candidates and job requirements.

Customizable Match Scoring Techniques: Implementations of the present disclosure may also enable customizable match scoring, which may take into account specific priorities of both the enterprise and domain/industry related to the enterprise. With the customizable match scoring, implementations of the present disclosure provide a tailored and dynamic approach to matching of the key attributes.

Superior Matching Accuracy with Deep Contextual Understanding: By employing embedding techniques, data augmentation using the LLMs, and customizable match scoring, implementations of the present disclosure may efficiently determine matched attribute pairs (each pair may include a key attribute from the primary documents and a respectively matched key attribute from the secondary documents) with high accuracy. For example, in case of talent matching, determining the matched attribute pairs by determining the contextual relevance between candidate profiles and job descriptions may ensure that the most appropriate candidates are matched with the right job roles, which increases likelihood of successful talent transitions, reduces turnover, and aids the organizations to optimize human resource strategies. Further, the match scores associated with each of the matched key attributes may be dynamically adjusted using a scoring mechanism that reflects priorities of the enterprise such as enterprise culture, enterprise objectives and strategies, thereby improving precision and relevance of matched key attributes.

Flexibility for Enterprise and Individual Matching: Implementations of the present disclosure may provide flexibility in handling and matching the key attributes extracted from the various documents. For example, implementations of the present disclosure may provide flexibility in handling both individual-level role matching and organizational-level talent transitions.

Gap Analyses: Implementations of the present disclosure may enable performing of gap analysis to determine any gap in the matched attribute pairs. For example, in case of talent matching or candidate recruitment, the gap analysis may be performed by analyzing both the current talent pool within the enterprise and required skills for target job roles in an industry. By leveraging the data sources and the LLMs, implementations of the present disclosure may aid the enterprise to identify the essential skills needed for emerging roles, ensuring that the skills are prepared to meet future workforce demands.

Precise Upskilling and Reskilling Recommendations: Implementations of the present disclosure may provide customized upskilling and reskilling strategies. Through use of the detailed gap analysis, optimal learning paths or upskilling paths may be recommended for the candidates, which aids the enterprise to prepare the workforce for upcoming demands. The customized upskilling and reskilling strategies may ensure that the candidates or employees are equipped with the right skills, making talent transitions smoother and more efficient. Providing the recommendations not only facilitates career development for individuals but also aids the organizations to maintain a highly skilled and competitive workforce.

Recommendations: Implementations of the present disclosure for generate recommendations to recommend transitions to be applied on the matched attribute pairs. For example, in case of talent matching or candidate recruitment, the recommendations may aid in transition of candidates from outdated roles to emerging or future-oriented positions, which may ensure workforce of the enterprise remains adaptable and competitive.

With the above-described advantages, implementations provide significant improvements ranging from reduced storage requirements, improved processing speed, enhanced security, and reduced utilization of computing resources.

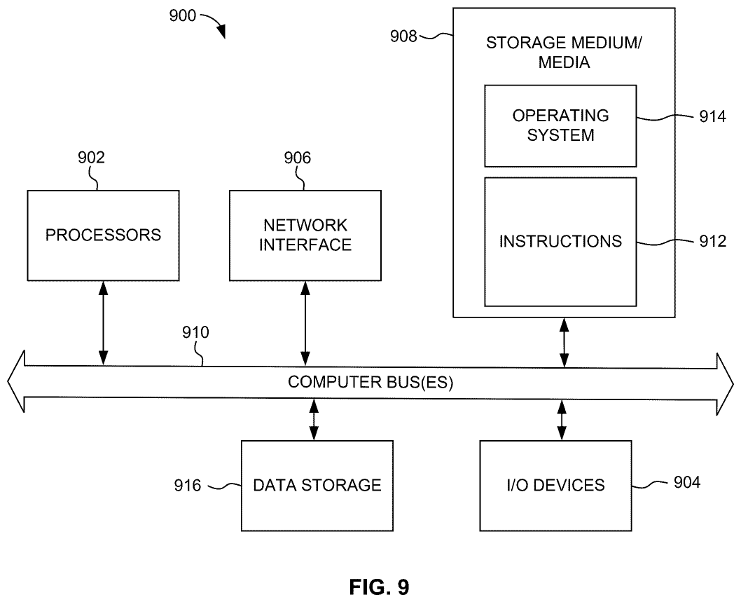

FIG. 9 depicts a computer system 900 that may be used to implement the method 500. More particularly, computing machines such as desktops, laptops, smartphones, tablets, and wearables which may be used for extracting and matching key attributes from documents. The computer system 900 may include additional components not shown and that some of the process components described may be removed and/or modified. In another example, the computer system 900 may be deployed on external-cloud platforms such as cloud, internal corporate cloud computing clusters, organizational computing resources, and/or the like.

The computer system 900 includes processor(s) 902, such as a central processing unit, ASIC or another type of processing circuit, input/output devices 904, such as a display, mouse keyboard, and/or the like, a network interface 906, such as a Local Area Network (LAN), a wireless 802.11x LAN, a 3G or 4G mobile WAN or a WiMax WAN, and a computer-readable medium 908. Each of these components may be operatively coupled to a bus 910. The computer-readable medium 908 may be any suitable medium that participates in providing instructions to the processor(s) 902 for execution. For example, the computer-readable medium 908 may be non-transitory or non-volatile medium, such as a magnetic disk or solid-state non-volatile memory or volatile medium such as RAM. The instructions or modules stored on the computer-readable medium 908 may include machine-readable instructions 912 executed by the processor(s) 902 that cause the processor(s) 902 to perform the method 500.

The computer system 900 may be implemented as software stored on a non-transitory processor-readable medium and executed by the processor(s) 902. For example, the computer-readable medium 908 may store an operating system 914, such as MAC OS, MS WINDOWS, UNIX, or LINUX, and code, for the computer system 900. The operating system 914 may be multi-user, multiprocessing, multitasking, multithreading, real-time, and the like. For example, during runtime, the operating system 914 is running and the code for the computer system 900 is executed by the processor(s) 902.

The computer system 900 may include a data storage 916, which may include non-volatile data storage. The data storage 916 stores any data used or generated by the computer system 900.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., a Field Programmable Gate Array (A SIC) or an Application Specific Integrated Circuit (A SIC).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 902 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a plurality of primary documents from a plurality of data sources, wherein the plurality of primary documents comprises synthetic datasets and raw datasets, wherein the plurality of primary documents comprises at least one of user demographic documents, user medical documents, user legal documents, and user compliance documents;
extract a plurality of primary key attributes from the received plurality of primary documents using a plurality of fine-tuned Large Language Models (LLMs), wherein the plurality of primary key attributes comprises at least one of user demographic data, user qualification data, user medical data, user compliance data, and user proficiency level data;
determine a plurality of secondary key attributes from a plurality of secondary documents, using the plurality of fine-tuned LLMs, wherein the plurality of secondary documents comprises at least one of target demographic documents, target medical documents, target legal documents, and target compliance documents, and wherein the plurality of secondary key attributes comprises at least one of target demographic data, target qualification data, target medical data, and target compliance data, and target proficiency level data;
validate the extracted plurality of primary key attributes, and the extracted plurality of secondary key attributes, using the plurality of fine-tuned LLMs;
determine a similarity between the plurality of primary key attributes, and the plurality of secondary key attributes based on results of validation, wherein the similarity is determined by applying a semantic similarity model onto the plurality of primary key attributes, and the plurality of secondary key attributes, and wherein the semantic similarity model comprises a cosine similarity model;
compute ontology scores for each of the plurality of primary key attributes and the plurality of secondary key attributes, based on the determined similarity, wherein the ontology scores correspond to a similarity level between the plurality of primary key attributes, and the plurality of secondary key attributes;
determine a plurality of matched attribute pairs, by comparing the computed ontology scores with a first predefined threshold value;
identify a gap level between each of the determined plurality of matched attribute pairs using the plurality of fine-tuned LLMs;
recommend a plurality of transitions to be applied to each of the plurality of matched attribute pairs, based on the identified gap level, wherein the plurality of transitions comprise performing modifications to the plurality of matched attribute pairs, to match with the first predefined threshold value; and
output the recommended plurality of transitions on an interface of a client device.

2. The system of claim 1, wherein the processor is configured to:
update the plurality of fine-tuned LLMs by continuously training the plurality of fine-tuned LLMs based on results of determination of the plurality of matched attribute pairs.

3. The system of claim 1, wherein to extract the plurality of primary key attributes from the received plurality of primary documents, using the plurality of fine-tuned LLMs the processor is configured to:
determine a proficiency level of the plurality of the primary key attributes, using the plurality of fine-tuned LLMs, wherein the proficiency level corresponds to a level of expertise associated with the user; and
generate the user proficiency level data, based on the determined proficiency level, wherein the user proficiency level data correspond to a dataset comprising the proficiency level of the plurality of the primary key attributes.

4. The system of claim 1, wherein to determine the plurality of secondary key attributes from the plurality of secondary documents, using the plurality of fine-tuned LLMs, the processor is configured to:
identify a plurality of primary key words in the received plurality of secondary documents, wherein the plurality of primary key words correspond to the plurality of secondary key attributes comprising a highest priority level;
identify a plurality of proficiency indicators in the received plurality of secondary documents, wherein the plurality of proficiency indicators corresponds to a plurality of secondary key words indicating the proficiency level of the plurality of secondary key attributes;
determine a proficiency level of the plurality of secondary key attributes, based on the identified plurality of primary key words, and the identified plurality of proficiency indicators; and
generate the target proficiency level data, based on the determined target proficiency level, wherein the target proficiency level data correspond to a dataset comprising the proficiency level of the plurality of secondary key attributes.

5. The system of claim 1, wherein to validate the plurality of primary key attributes, and the secondary key attributes, using the plurality of fine-tuned LLMs, the processor is further configured to:
identify a semantic pair for each of the extracted plurality of primary key attributes, and each of the extracted plurality of secondary key attributes;
compare the identified semantic pair with a second predefined threshold value;
determine a plurality of delta key attributes of the semantic pair, based on the comparison, wherein the plurality of delta key attributes corresponds to the semantic pair failing to exceed the second predefined threshold value;
determine a plurality of validated key attributes, based on the comparison, wherein the plurality of validated key attributes corresponds to the semantic pair exceeding the second predefined threshold value;
determine key attribute data, based on the determined plurality of delta key attributes, and the determined plurality of validated key attributes, wherein the key attribute data correspond to a combination of the determined plurality of delta key attributes, and the determined plurality of validated key attributes;
identify the similarity between each of the plurality of delta key attributes, and each of the plurality of validated key attributes, within the key attribute data; and
create a final attribute dataset by filtering a plurality of similar key attributes from the key attribute data, based on the identified similarity.

6. The system of claim 1, wherein to determine the similarity between the plurality of primary key attributes, and the plurality of secondary key attributes based on results of validation, the processor is configured to:
generate primary description data for the plurality of primary key attributes using a Generative Artificial Intelligence (AI)-based model, wherein the primary description data correspond to a detailed textual description of each of the plurality of primary key attributes;
generate a plurality of primary attribute embeddings by converting the primary description data into a vector embedded representation, using a plurality of embedding models;
generate secondary description data for the plurality of secondary key attributes using the Gen AI model, wherein the secondary description data correspond to a detailed textual description of each of the plurality of secondary key attributes;
generate a plurality of secondary attribute embeddings by converting the secondary description data into the vector embedded representation, using the plurality of embedding models;
compare the generated plurality of primary attribute embeddings with the generated plurality of secondary attribute embeddings; and
determine the similarity between the generated plurality of primary attribute embeddings, and the generated plurality of secondary attribute embeddings, by applying the semantic similarity model on the plurality of primary attribute embeddings, and the plurality of secondary attribute embeddings, based on the comparison.

7. The system of claim 6, wherein to compare the generated plurality of primary attribute embeddings with the generated plurality of secondary attribute embeddings, the processor is further configured to:
pre-process the generated primary description data, and the secondary description data by filtering a plurality of external attributes from the generated primary description data, and the secondary description data, wherein the plurality of external attributes comprises at least one of non-American Standard Code for Information Interchange (ASCII) values, special characters, HyperText Markup Language (HTML) tags, stop words, punctuation, and unwanted characters;
convert the pre-processed primary description data, and the secondary description data into a plurality of tokenized inputs relevant to the plurality of embedding models;
generate a plurality of token embeddings, by inputting the plurality of tokenized inputs into the plurality of embedding models;
compute a plurality of sentence embeddings, based on the generated plurality of token embeddings;
convert the plurality of sentence embeddings into a dataframe, wherein the dataframe comprises the plurality of primary attribute embeddings and the generated plurality of secondary attribute embeddings in form of rows and columns; and
compare the generated plurality of primary attribute embeddings with the generated plurality of secondary attribute embeddings, based on the created dataframe.

8. The system of claim 1, wherein to compute the ontology scores for each of the plurality of primary key attributes and the plurality of secondary key attributes, based on the determined similarity, the processor is further configured to:
determine an angle of similarity between a plurality of primary attribute embeddings associated with the plurality of primary key attributes, and a plurality of secondary attribute embeddings associated with the plurality of secondary key attributes;
determine an orientation of the plurality of primary attribute embeddings relative to the plurality of secondary attribute embeddings, based on the determined angle of similarity; and
compute the ontology scores for each of the plurality of primary key attributes and the plurality of secondary key attributes, based on the determined orientation.

9. The system of claim 1, wherein to determine the plurality of matched attribute pairs, by comparing the computed ontology scores with the first predefined threshold value, the processor is configured to:
determine a primary match score, based on a weighted average of the computed ontology scores;
update the primary match score, based on at least one of a relevancy factor, a proficiency delta value, an alignment value, a minimum proximity threshold value, and a proximity percentage value;
generate a net match score, based on the updated primary match score, wherein the net match score corresponds to an updated primary match score controlled based on at least one of the relevancy factor, the proficiency delta value, the alignment value, the minimum proximity threshold value, and the proximity percentage value;
identify a mismatch between attribute level of the primary key attributes, and the secondary key attributes; and
update the net match score, based on the mismatch identified between the attribute level of the primary key attributes, and the secondary key attributes.

10. The system of claim 1, wherein to identify the gap level between each of the determined plurality of matched attribute pairs, using the plurality of fine-tuned LLMs, the processor is configured to:
determine a plurality of baseline attributes, upon determining that the computed ontology scores exceeding the first predefined threshold value;
determine a plurality of low-grade attributes, upon identifying the computed ontology scores failing to meet the first predefined threshold value; and
compare the plurality of baseline attributes with the plurality of low-grade attributes; and
identify the gap level between the plurality of baseline attributes, and the plurality of low-grade attributes, based on the comparison, wherein the gap level corresponds to a gap in the similarity level between the determined plurality of matched attribute pairs.

11. The system of claim 1, wherein to recommend the plurality of transitions to be applied for each of the plurality of matched attribute pairs, based on the identified gap level, the processor is configured to:
compute a relevance index value for the each of the plurality of matched attribute pairs, based on at least one of a demand factor, a market trend factor, and a prioritization factor, wherein the relevance index value corresponds to a relevancy level of the plurality of secondary key attributes with respect to the plurality of secondary documents;
determine an optimal learning pathway data based on a weighted average of the computed relevance index value, and each of the computed ontology scores, wherein the optimal learning pathway data comprise at least one of the plurality of matched attribute pairs to be updated, sorted in a descending order of the computed relevance index value, and wherein the optimal learning pathway data comprise at least one of the plurality of similar matched attribute pairs sorted in the descending order of the computed relevance index value; and
recommend the plurality of transitions to be applied for each of the plurality of matched attribute pairs, based on the determined optimal learning pathway data.

12. The system of claim 1, wherein to extract the plurality of primary key attributes from the received plurality of primary documents, using a plurality of fine-tuned LLMs, the processor is configured to:
generate a plurality of prompts for each of the plurality of primary documents, wherein the plurality of prompts comprises at least user defined instructions for extracting the plurality of primary key attributes; and
extract the plurality of primary key attributes, using the plurality of fine-tuned LLMs, based on the generated plurality of prompts.

13. The system of claim 3, wherein to determine the proficiency level of the plurality of the primary key attributes, using the plurality of fine-tuned LLMs, the processor is configured to:
identify a plurality of key indicators associated with the plurality of primary key attributes;
generate a graphical representation of the plurality of primary key attributes, based on the identified plurality of key indicators;
identify the similarity between the plurality of primary key attributes, based on the generated graphical representation;
create a clustered data by clustering the similar plurality of primary key attributes into a plurality of cluster groups;
create an aggregated data by aggregating a period of usage value of each of the plurality of primary key attributes in the created clustered data; and
determine the proficiency level of each of the plurality of primary key attributes, based on the aggregated data.

14. The system of claim 13, wherein to identify the plurality of key indicators associated with the plurality of primary key attributes, the processor is configured to:
identify a plurality of predefined keywords in the plurality of primary key attributes;
identify the period of usage value of each of the plurality of primary key attributes, based on the identified plurality of predefined keywords; and
identify a frequency of occurrence of each of the plurality of primary key attributes, based on the identified period usage value.

15. A method comprising:
receiving, by a processor, a plurality of primary documents from a plurality of data sources, wherein the plurality of primary documents comprises synthetic datasets and raw datasets, wherein the plurality of primary documents comprises at least one of user demographic documents, user medical documents, user legal documents, and user compliance documents;
extracting, by the processor, a plurality of primary key attributes from the received plurality of primary documents, using a plurality of fine-tuned Large Language Models (LLMs), wherein the plurality of primary key attributes comprises at least one of a user demographic data, a user qualification data, a user medical data, a user compliance data, and a user proficiency level data;
determining, by the processor, a plurality of secondary key attributes from a plurality of secondary documents, using the plurality of fine-tuned LLMs, wherein the plurality of secondary documents comprises at least one of target demographic documents, target medical documents, target legal documents, and target compliance documents, and wherein the plurality of secondary key attributes comprises at least one of a target demographic data, a target qualification data, a target medical data, and a target compliance data, and a target proficiency level data;
validating, by the processor, the extracted plurality of primary key attributes, and the extracted plurality of secondary key attributes, using the plurality of fine-tuned LLMs;
determining, by the processor, a similarity between the plurality of primary key attributes, and the plurality of secondary key attributes based on results of validation, wherein the similarity is determined by applying a semantic similarity model onto the plurality of primary key attributes, and the plurality of secondary key attributes, and wherein the semantic similarity model comprises a cosine similarity model;
computing, by the processor, ontology scores for each of the plurality of primary key attributes and the plurality of secondary key attributes, based on the determined similarity, wherein the ontology scores correspond to a similarity level between the plurality of primary key attributes, and the plurality of secondary key attributes;
determining, by the processor, a plurality of matched attribute pairs, by comparing the computed ontology scores with a first predefined threshold value;
identifying, by the processor, a gap level between each of the determined plurality of matched attribute pairs using the plurality of fine-tuned LLMs;
recommending, by the processor, a plurality of transitions to be applied to each of the plurality of matched attribute pairs, based on the identified gap level, wherein the plurality of transitions comprises performing modifications to the plurality of matched attribute pairs, to match with the first predefined threshold value; and
outputting, by the processor, the recommended plurality of transitions on an interface of a client device.

16. The method of claim 15, further comprising:
updating, by the processor, the plurality of fine-tuned LLMs by continuously training the plurality of fine-tuned LLMs based on results of determination of the plurality of matched attribute pairs.

17. The method of claim 15, wherein extracting the plurality of primary key attributes from the received plurality of primary documents, using the plurality of fine-tuned LLMs, comprises:
determining, by the processor, a proficiency level of the plurality of the primary key attributes, using the plurality of fine-tuned LLMs, wherein the proficiency level corresponds to a level of expertise associated with the user; and
generating, by the processor, the user proficiency level data, based on the determined proficiency level, wherein the user proficiency level data correspond to a dataset comprising the proficiency level of the plurality of the primary key attributes.

18. The method of claim 15, wherein determining the plurality of secondary key attributes from the plurality of secondary documents, using the plurality of fine-tuned LLMs, comprises:
identifying, by the processor, a plurality of primary key words in the received plurality of secondary documents, wherein the plurality of primary key words corresponds to the plurality of secondary key attributes comprising a highest priority level;
identifying, by the processor, a plurality of proficiency indicators in the received plurality of secondary documents, wherein the plurality of proficiency indicators corresponds to a plurality of secondary key words indicating the proficiency level of the plurality of secondary key attributes;
determining, by the processor, a proficiency level of the plurality of secondary key attributes, based on the identified plurality of primary key words, and the identified plurality of proficiency indicators; and
generating, by the processor, the target proficiency level data, based on the determined target proficiency level, wherein the target proficiency level data correspond to a dataset containing the proficiency level of the plurality of secondary key attributes.

19. The method of claim 15, wherein validating the plurality of primary key attributes, and the secondary key attributes, using the plurality of fine-tuned LLMs, comprises:
identifying, by the processor, a semantic pair for each of the extracted plurality of primary key attributes, and each of the extracted plurality of secondary key attributes;
comparing, by the processor, the identified semantic pair with a second predefined threshold value;
determining, by the processor, a plurality of delta key attributes of the semantic pair, based on the comparison, wherein the plurality of delta key attributes corresponds to the semantic pair failing to exceed the second predefined threshold value;
determining, by the processor, a plurality of validated key attributes, based on the comparison, wherein the plurality of validated key attributes corresponds to the semantic pair exceeding the second predefined threshold value;
determining, by the processor, a key attribute data, based on the determined plurality of delta key attributes, and the determined plurality of validated key attributes, wherein the key attribute data correspond to a combination of the determined plurality of delta key attributes, and the determined plurality of validated key attributes;
identifying, by the processor, the similarity between each of the delta key attributes, and each of the validated key attributes, within the key attribute data; and
creating, by the processor, a final attribute dataset by filtering a plurality of similar key attributes from the key attribute data, based on the identified similarity.

20. A non-transitory computer readable medium comprising a processor-executable instructions that cause a processor to:
receive a plurality of primary documents from a plurality of data sources, wherein the plurality of primary documents comprises synthetic datasets and raw datasets, wherein the plurality of primary documents comprises at least one of user demographic documents, user medical documents, user legal documents, and user compliance documents;
extract a plurality of primary key attributes from the received plurality of primary documents, using a plurality of fine-tuned Large Language Models (LLMs), wherein the plurality of primary key attributes comprises at least one of a user demographic data, a user qualification data, a user medical data, a user compliance data, and a user proficiency level data;
determine a plurality of secondary key attributes from a plurality of secondary documents, using the plurality of fine-tuned LLMs, wherein the plurality of secondary documents comprises at least one of target demographic documents, target medical documents, target legal documents, and target compliance documents, and wherein the plurality of secondary key attributes comprises at least one of a target demographic data, a target qualification data, a target medical data, and a target compliance data, and a target proficiency level data;
validate the extracted plurality of primary key attributes, and the extracted plurality of secondary key attributes, using the plurality of fine-tuned LLMs;
determine a similarity between the plurality of primary key attributes, and the plurality of secondary key attributes based on results of validation, wherein the similarity is determined by applying a semantic similarity model onto the plurality of primary key attributes, and the plurality of secondary key attributes, and wherein the semantic similarity model comprises a cosine similarity model;
compute ontology scores for each of the plurality of primary key attributes and the plurality of secondary key attributes, based on the determined similarity, wherein the ontology scores correspond to a similarity level between the plurality of primary key attributes, and the plurality of secondary key attributes;
determine a plurality of matched attribute pairs, by comparing the computed ontology scores with a first predefined threshold value;
identify a gap level between each of the determined plurality of matched attribute pairs using the plurality of fine-tuned LLMs;
recommend a plurality of transitions to be applied to each of the plurality of matched attribute pairs, based on the identified gap level, wherein the plurality of transitions comprises performing modifications to the plurality of matched attribute pairs, to match with the first predefined threshold value; and
output the recommended plurality of transitions on an interface of a client device.
